(19) United States
(12) Patent Application Publication
(10) Pub. No.: US 2024/0050912 A1
(43) Pub. Date: Feb. 15, 2024

(54) Micron Sized Droplets With Solid Endoskeleton or Exoskeleton Which Tunes The Thermal Stability of The Liquid Droplets

(71) Applicant: The Regents of the University of Colorado, a body corporate, Denver, CO (US)

(72) Inventors: Mark A. Borden, Boulder, CO (US); Gazendra Shakya, Westminster, CO (US); Xiaoyun Ding, Superior, CO (US)

(21) Appl. No.: 17/766,387

(22) PCT Filed: Sep. 30, 2020
(86) PCT No.: PCT/US2020/053627

§ 371 Date: Apr. 4, 2022

Related U.S. Application Data
(60) Provisional application No. 62/911,119, filed on Oct. 4, 2019.

(51) Int. Cl. B01J 13/00; B01J 13/08; C09K 5/04

(52) U.S. Cl. CPC B01J 13/0021; B01J 13/08; C09K 5/048

(57) ABSTRACT

The inventive technology is directed to droplet compositions having novel endoskeletal and/or exoskeletal shell architectures configured to produce enhanced vaporization characteristics.

This International PCT Application claims the benefit of and priority to U.S. Provisional Application No. 62/911,119, filed Oct. 4, 2019. The entire specification and figures of the above-referenced application is hereby incorporated, in its entirety by reference.

### GOVERNMENT INTEREST

This invention was made with government support under grant number CA195051 awarded by the National Institutes of Health. The government has certain rights in the invention.

### TECHNICAL FIELD

The inventive technology is directed to droplet compositions having novel endoskeletal and/or exoskeletal shell architectures configured to produce enhanced vaporization characteristics.

### BACKGROUND

Vaporizable droplets are a special class of reconfigurable complex emulsions that have broad applications in ultrasonics, microfluidics, energy storage, heat transfer, chemical reactions and high-energy particle detection. The liquid-to-gas phase transition drastically changes the particle's physical properties, especially its size and compressibility, which facilitates sensing and actuation. Droplet vaporization is typically triggered thermally or acoustically by exceeding the thermodynamic limit of stability (spinodal), or by solid structures that facilitate heterogeneous nucleation. Notably, vaporization of a liquid emulsion droplet to a gas microbubble leads to a volumetric increase by over two orders of magnitude, along with corresponding changes in the particle's density, compressibility, heat capacity and other thermophysical properties. This transformation can be exploited for myriad applications as noted above. In ultrasonics, for example, a relatively passive liquid droplet can be transformed by vaporization into a highly echogenic and acoustically active particle for imaging and therapy. On a microfluidic chip, the microbubble can facilitate fluid mixing and catalyze chemical reactions among other things. Droplet vaporization can also be used to detect high-energy particles.

Droplet vaporization is both a thermodynamic and a kinetic phenomenon. Thermodynamically, the droplet should vaporize at the boiling point of the liquid phase so long as there is a heterogeneous surface on which to stabilize a vapor embryo. Without such a surface, however, this may take a long time kinetically as droplets can be superheated to a metastable state owing to the energy barrier for critical vapor embryo nucleation. As noted above, the spinodal is the theoretical temperature limit that a droplet can be heated to before it spontaneously vaporizes without heterogeneous nucleation. Based on theoretical and experimental observations, the spinodal temperature is usually taken at 80-90% of the critical temperature (T_{c}), which is the temperature at which the differences between the gas and liquid states disappear.

Perfluorocarbon droplets have been extensively used as phase-change contrast agents for biomedical ultrasound imaging. The phase-change behavior of these droplets is governed by their intermolecular forces. Several studies have aimed at understanding the vapor embryo nucleation and vaporization behavior of these droplets. However, these studies largely use the critical temperature of the pure fluorocarbon species to tune phase-change behavior and have not looked at tuning of the thermodynamic limit of stability (spinodal) by using heterogeneous mixtures. Controlling the spinodal by altering the intermolecular forces of the volatile mixture may allow better control over the phase-change behavior.

### SUMMARY OF THE INVENTION(S)

As detailed below, the present inventors investigated the vaporization behavior of different fluorocarbon and hydrocarbon mixtures. Solid alkanes (ranging from 18- to 24-carbon chain length) were used with perfluoropentane as the volatile liquid to make endoskeletal (solid-in-liquid) droplets. Vaporization of these endoskeletal droplets were tested over a range of temperatures. Surprisingly, the inventors show that the endoskeletal droplets vaporized near the melting point of the solid hydrocarbon phase. The present inventors were further able to vary the vaporization temperature of the droplets from 23° C. to 45° C. depending on the hydrocarbon species used. Using a simple statistical thermodynamics lattice model, the present inventors demonstrate that the presence of the hydrocarbon breaks the intermolecular attraction between the fluorocarbon molecules, making it possible to finely tune its spinodal and consequently the vaporization temperature.

In aspect embodiment of the invention, the present inventors have demonstrated tunability in the vaporization temperature of vaporizable droplets having a solid exoskeleton or endoskeleton shell that induces changes in the vaporization temperature of the droplet. In another embodiment of the invention, the vaporization temperature of the droplet may be varied based on the type of solid used to generate the solid exoskeleton or endoskeleton shell.

In aspect embodiment of the invention, the present inventors have demonstrated methods for the fabrication and use of novel vaporizable droplets having a solid exoskeleton or endoskeleton shell that induces changes in the vaporization temperature of the droplet. Example applications for such novel vaporizable droplets having a solid exoskeleton or endoskeleton shell that induces changes in the vaporization temperature of the droplet may include, but not be limited to: therapeutic imaging and therapy, heat-transfer applications, targeted drug delivery, delivery of therapeutic biologic molecules, high-energy particle detection, microfluidic chip applications, facilitate fluid mixing on microfluidic applications, and catalyze chemical reactions among other applications.

Additional aspect of the invention may include one or more of the following embodiments:
1. A composition comprising:
   a liquid phase fluorocarbon vaporizable droplet incorporating a solid phase compound comprising at least one of the following:
      a solid phase fluorocarbon (FC);
      a solid phase hydrocarbon (HC);
      a mixture of a solid phase FC and a solid phase HC;
      a mixture of two or more solid phase HCs; and
   wherein said solid phase compound forms a solid state exoskeleton or endoskeleton shell configured to tune the vaporization temperature of said fluorocarbon vaporizable droplet.
2. The composition of embodiment 1 wherein said liquid phase fluorocarbon comprises a liquid phase perfluoropentane vaporizable droplet, or a liquid phase perfluorohexane vaporizable droplet.
3. The composition of embodiment 2 wherein said solid phase FC comprises a solid phase perfluorododecane.
4. The composition of embodiment 3 wherein said solid phase perfluorododecane forms a solid endoskeleton shell that is encapsulated by said liquid phase perfluorohexane vaporizable droplet.
5. The composition of embodiment 4 wherein said endoskeleton shell comprises a disk-shaped solid structure encapsulated by said liquid phase fluorocarbon vaporizable droplet.
6. The composition of embodiment 3 wherein said liquid phase perfluoropentane vaporizable droplet encapsulating said perfluorododecane solid endoskeleton shell stabilizes said perfluoropentane vaporizable droplet increasing the temperature of vaporization of the droplet.
6.1 The composition of embodiment 4 wherein said liquid perfluorohexane vaporizable droplet encapsulating said perfluorododecane solid endoskeleton shell stabilizes said perfluorohexane vaporizable droplet increasing the vaporization temperature of the droplet.
7. The composition of embodiment 1 wherein said solid phase HC comprises a straight chain alkane having a chain length between 18-24 carbons.
8. The composition of embodiment 7 wherein said solid phase HC comprises a solid phase HC selected from the group consisting of: octadecane, eicosane, docosane, tetracosane, or a mixture of the same.
9. The composition of embodiment 1 wherein said liquid phase fluorocarbon comprises:
   a liquid phase perfluoropentane vaporizable droplet or a liquid phase perfluorohexane vaporizable droplet incorporating a solid phase compound comprising both:
      a solid phase HC; and
      a solid phase FC;
   wherein said solid phase HC and said solid phase FC form a solid state endoskeleton shell that decreases the vaporization temperature of the droplet.
10. The composition of embodiment 9 wherein said solid phase HC comprises a straight chain alkane having a chain length between 18-24 carbons.
11. The composition of embodiment 9 wherein said solid phase FC comprises solid phase perfluorododecane.
12. The composition of embodiment 1 wherein said liquid phase fluorocarbon comprises a liquid phase perfluoropentane vaporizable droplet incorporating a solid phase compound comprising two or more solid phase HCs wherein said two or more solid phase HCs form a solid state endoskeleton shell and/or exoskeleton shell that decreases the vaporization temperature of the droplet.
13. The composition of embodiment 12 wherein said two or more solid phase HCs comprise two or more straight chain alkanes having a chain length between 18-24 carbons.
14. The composition of embodiment 13 wherein said two or more straight chain alkanes having a chain length between 18-24 carbons are selected from the group consisting of: eicosane, docosane, tetracosane, or a mixture of the same.
15. The composition of embodiments 13 and 14 wherein said decrease in the vaporization temperature of the droplet is induced by the melting transition of the two or more HCs and not heterogeneous nucleation.
16. A method of tuning the vaporization temperature of a droplet comprising:
   generating liquid phase fluorocarbon vaporizable droplet; and
   introducing one or more solid phase compounds to said liquid phase fluorocarbon vaporizable droplet, wherein said one or more solid phase compounds form a solid state exoskeleton or endoskeleton shell configured to tune the vaporization temperature of said fluorocarbon vaporizable droplet.
17. The method of embodiment 16 wherein said liquid phase fluorocarbon vaporizable droplet comprises a liquid phase perfluoropentane vaporizable droplet, or a liquid phase perfluorohexane vaporizable droplet.
18. The method of embodiment 17 wherein said solid phase compounds comprise a compound selected from the group consisting of:
   at least one solid phase fluorocarbon (FC);
   at least one solid phase hydrocarbon (HC);
   a mixture of at least one solid phase FC and at least one solid phase HC; and
   a mixture of two or more solid phase HCs.
19. The method of embodiment 18 wherein said solid phase FC comprises a solid phase perfluorododecane.
20. The method of embodiment 19 wherein said solid phase perfluorododecane forms a solid endoskeleton shell that is encapsulated by said liquid phase perfluorohexane vaporizable droplet.
21. The method of embodiment 20 wherein said endoskeleton shell comprises a disk-shaped solid structure encapsulated by said liquid phase fluorocarbon vaporizable droplet.
22. The method of embodiment 19 wherein said liquid phase perfluoropentane vaporizable droplet encapsulating said perfluorododecane solid endoskeleton shell stabilizes said perfluoropentane vaporizable droplet increasing the temperature of vaporization of the droplet.
23. The method of embodiment 20 wherein said liquid perfluorohexane vaporizable droplet encapsulating said perfluorododecane solid endoskeleton shell stabilizes said perfluorohexane vaporizable droplet increasing the vaporization temperature of the droplet.
24. The method of embodiment 18 wherein said at least one solid phase HC comprises a straight chain alkane having a chain length between 18-24 carbons.
25. The method of embodiment 24 wherein said at least one solid phase HC comprises a solid phase HC selected from the group consisting of: octadecane, eicosane, docosane, tetracosane, or a mixture of the same.
26. The method of embodiment 16 liquid phase fluorocarbon comprises:
   a liquid phase perfluoropentane vaporizable droplet or a liquid phase perfluorohexane vaporizable droplet incorporating a solid phase compound comprising both:
      at least one solid phase HC;
      at least one solid phase FC; and
   wherein said solid phase HC and said solid phase FC form a solid state endoskeleton shell that decreases the vaporization temperature of the droplet.
27. The method of embodiment 26 wherein said solid phase HC comprises a straight chain alkane having a chain length between 18-24 carbons.
28. The method of embodiment 26 wherein said solid phase FC comprises solid phase perfluorododecane.
29. The method of embodiment 16 wherein said liquid phase fluorocarbon comprises a liquid phase perfluoropentane vaporizable droplet incorporating a solid phase compound comprising two or more solid phase HCs wherein said two or more solid phase HCs form a solid state endoskeleton shell and/or exoskeleton shell that decreases the vaporization temperature of the droplet.
30. The method of embodiment 29 wherein said two or more solid phase HCs comprise two or more straight chain alkanes having a chain length between 18-24 carbons.
31. The method of embodiment 30 wherein said two or more straight chain alkanes having a chain length between 18-24 carbons are selected from the group consisting of: eicosane, docosane, and tetracosane, or a mixture of the same.
32. The method of embodiment 30 and 31 wherein said decrease in the vaporization temperature of the droplet is induced by the melting transition of the two or more HCs and not heterogeneous nucleation.
33. A method of fabricating a tunable fluorocarbon vaporizable droplet having a solid state architecture comprising:
   heating a quantity of at least one fluorocarbon to form a liquefied fluorocarbon;
   introducing at least one fluorosurfactant to said liquefied fluorocarbon;
   introducing a quantity of at least one solid state fluorocarbon to said liquefied fluorocarbon forming a liquid and solid state fluorocarbon solution;
   heating said liquid and solid state fluorocarbon solution;
   extruding or emulsifying said liquid and solid state fluorocarbon solution forming a plurality fluorocarbon vaporizable droplet; and
   cooling said plurality fluorocarbon vaporizable droplets wherein said solid state fluorocarbon forms a solid state endoskeleton shell configured to tune the vaporization temperature of said fluorocarbon vaporizable droplet.
34. The method of embodiment 33 wherein said one or more steps of fabricating are done in a closed system such that pressure is increased during said step of heating.
35. The method of embodiment 33 wherein one or more steps of fabricating are done in a microfluidic device.
36. The method of embodiment 33 wherein said step of heating comprises heating a quantity of at least one perfluoropentane to form a liquefied perfluoropentane.
37. The method of embodiment 33 wherein said fluorosurfactant comprises krytox.
38. The method of embodiment 33 and further comprising the step of adding a quantity of deionized water.
39. The method of embodiment 33 wherein said step of introducing a quantity of at least one solid state fluorocarbon to said liquefied fluorocarbon comprises the step of introducing a quantity of perfluorododecane to said liquefied fluorocarbon.
40. The method of embodiment 39 wherein said perfluorododecane solid endoskeleton shell stabilizes said perfluoropentane vaporizable droplet increasing the temperature of vaporization of the droplet
41. A method of fabricating a tunable fluorocarbon vaporizable droplet having a solid state architecture comprising:
   liquefying a quantity of at least one solid state hydrocarbon to form a liquefied hydrocarbon;
   introducing at least one surfactant or lipid solution to said liquefied hydrocarbon;
   introducing a quantity of deionized water to said liquefied hydrocarbon;
   introducing a quantity of at least one liquid state fluorocarbon to said liquefied hydrocarbon forming a liquid and solid state solution;
   heating said liquid and solid state solution;
   extruding or emulsifying said liquid and solid state solution forming a plurality fluorocarbon vaporizable droplet; and
   quenching said plurality fluorocarbon vaporizable droplets wherein said solid state hydrocarbon forms a solid state exoskeleton or endoskeleton shell configured to tune the vaporization temperature of said fluorocarbon vaporizable droplet.
42. The method of embodiment 41 wherein said one or more steps of fabricating are done in a closed system such that pressure is increased during said step of heating.
43. The method of embodiment 41 wherein said one or more steps of fabricating are done in a microfluidic device.
44. The method of embodiment 41 wherein said step of liquefying a quantity of at least one solid state hydrocarbon to form a liquefied hydrocarbon comprises liquefying a quantity of at least one solid state straight chain alkane having a chain length between 18-24 carbons to form a liquefied hydrocarbon.
45. The method of embodiment 44 wherein said straight chain alkane having a chain length between 18-24 carbons is selected from the group consisting of: octadecane, eicosane, docosane, tetracosane, or a mixture of the same
46. The method of embodiment 41 wherein said liquid state fluorocarbon comprises liquid state perfluoropentane.
47. The method of embodiment 41 wherein said fluorosurfactant comprises krytox.
48. The method of embodiment 41 introducing a quantity of at least one liquid state fluorocarbon to said liquefied hydrocarbon forming a liquid and solid state solution comprises the step of introducing a quantity of liquid state perfluorododecane to said liquefied hydrocarbon forming a liquid and solid state solution.
49. The method of embodiment 41 wherein said solid state hydrocarbon forms a solid state exoskeleton or endoskeleton shell decreasing the temperature of vaporization of the droplet.
50. Any composition or method as described in the above embodiments and further applied to one or more of the following technology fields: ultrasonics, microfluidics, energy storage, heat transfer, chemical reactions and high-energy particle detection

### BRIEF DESCRIPTION OF THE DRAWINGS

The above and other aspects, features, and advantages of the present disclosure will be better understood from the following detailed descriptions taken in conjunction with the accompanying figures, all of which are given by way of illustration only, and are not limiting the presently disclosed embodiments, in which:

FIG. 1: Synthesis and characterization of FC/FC endoskeletal droplets. a, Step-by-step emulsion synthesis process. b, Brightfield microscope image of the endoskeletal droplets showing the unique disk-in-sphere morphology, where C₁₂F₂₆ forms the solid phase and C₅F₁₂ forms the encapsulating liquid droplet. Blue arrows show side-orientated disks, and white arrows show top-orientated disks; scale bar, 20 μm. Insert shows a fluorescent image with a side-oriented disk; scale bar, 10 μm. The disks were observed to rotate inside the droplets when disturbed by the fluid flow (FIG. 11). c, At room temperature (25° C.), the disk is solid (bottom right). As the droplet is heated, the disk melts (bottom left) and decreases in size until it completely dissolves at a higher temperature (top left). When cooled, the same droplet solidifies by going through a non-spherical phase (top right) and finally forming the sold disk inside the droplet; scale bar, 10 μm. d, Diagram of Tₘ vs C₁₂F₂₆ content shows that the melting depends on droplet composition for two different liquid volatile species: C₅F₁₂ (filled black squares) and C₆F₁₄ (filled red circles). e, Tc (red), Tₛ (green) and T_{b} (black) prediction for a mixture of C₅F₁₂ and C₁₂F₂₆. Note that the spinodal range and experimental temperature range (patterned black lines) do not overlap for this mixture.

FIG. 2: Synthesis and characterization of FC/HC endoskeletal droplets. a, Step-by-step emulsification process with HC as the solid skeletal structure. b, Schematic of the slide setup and side view showing the bimodal density of droplets. c and d, Brightfield microscope images of the different droplet species. FC-rich droplets shown in c are spherical and sedimentary; hence they sink to the bottom of the slide. Insert in c shows a zoomed-in view of a droplet. Time lapse images below c show the vaporization process of a typical FC-rich droplet. Alternatively, HC-rich droplets seen in d are nonspherical in shape and buoyant. Insert in d shows a zoomed-in view of a droplet to illustrate the HC skeleton. Time lapse images below d show the vaporization process of the HC-rich droplet. Upon vaporization, the HC skeleton remains attached to the bubble and then slowly spreads over the bubble surface. The more solid HC-rich droplets tended to vaporize more slowly than the more liquid FC-rich droplets (FIGS. 13 and 14). Scale bar, 20 μm for all images.

FIG. 3: Vaporization properties of HC/FC droplets. a, T_{c} (red), Tₛ (green) and T_{b} (black) prediction for a mixture of C₅F₁₂ and C₁₈H₃₈. Note that the spinodal range and experimental temperature range (patterned black lines) overlap for this mixture. b, Images from molecular dynamics simulation of a FC (blue) and HC (red) mixture before (top) and after (bottom) equilibrium showing the interfacial mixing region. Scale bar, 1 nm. c, Mole fractions of HC and FC in the interfacial region calculated from MD simulation after 0.5 ns (dotted line showing interfacial region before mixing) and after 24 ns (solid line showing interfacial region after mixing) (shown in b). The grey highlight shows the concentration region where vaporization is expected to take place as per a. d, The interfacial energy during the transition from a sharp phase boundary to equilibrium (red) and the energy of a premixed system (blue) as a function of simulation time. The interfacial energy, given as the total change in inner energy in the interfacial region normalized per cross-sectional area, increases upon mixing which is consistent with lowering the vaporization energy and the vaporization temperature. The error bars represent standard deviation taken in 0.5 ns block averages over 7 ns in the equilibrium region. e, Typical vaporization curves for C₅F₁₂/C₁₈H₃₈ droplets (red) and C₅F₁₂/C₂₄H₅₀ droplets (black). Solid lines represent a normal cumulative distribution function fit. Arrows indicate how the vaporization temperature was calculated from each run. f, Linear dependence of the FC droplet vaporization temperature (mean±standard deviation) of the droplets vs. the HC melting point. Red triangles represent droplets stabilized by a fluorosurfactant (krytox) and black squares represent droplets stabilized by a hydrocarbon surfactant (lipids). The black dotted line shows the unity slope with zero offset. g, Where HC/HC mixtures were used for the skeletal phase, the relationship between the droplet vaporization temperature and fraction of longer HC chain was nonlinear owing to the o-d transition to the rotator phase. Black squares represent C₂₀H₄₂/C₂₂H₄₆, and red squares represent C₂₂H₄₆/C₂₄H₅₀ as the solid HC phase.

FIG. 4: Acoustic verification of the linear dependence of FC droplet vaporization temperature with HC skeleton melting point. a, Setup used for ultrasound experiments. b-c, B-mode image of the cross section of a tube filled with endoskeletal droplets at different temperatures. Ultrasound waves are travelling from right to left. Red circles represent the ROI selected for image analysis. The bright vertical line on the top left is the thermocouple. The brighter image in c is due to echogenic bubbles formed by droplet vaporization at the higher temperature. Scale bar, 1 mm. d, Typical video Intensity curves for C₅F₁₂/C₁₈H₃₈ droplets (red) and C₅F₁₂/C₂₄H₅₀ droplets (black). Solid line represents a Gaussian fit done on the data points. Arrows denote how the vaporization temperature was estimated. e, Linear dependence of the FC droplet vaporization temperature (mean±standard deviation) with the HC melting point. Red triangles represent droplets stabilized by a fluorosurfactant (krytox) and black squares represent droplets stabilized by a hydrocarbon surfactant (lipids).

FIG. 5: Setup used for optical heating experiments. A plastic gasket with a sample well and thermocouple two thermocouple ports is sandwiched between glass slides and mounted onto a microscope stage. A PID controller actuates flexible heaters mounted on the sides to reach the desired temperature. The blowup of the sample shows an example of newly vaporized bubbles.

FIG. 6: Modeling results for different mixtures. a. χ values for mixtures of perfluoropentane (C₅F₁₂) and various materials. χ values are very low for FC/FC mixture compared to FC/HC mixtures. b. Consequent values for vapor pressure for different concentrations of C₅F₁₂ in the mixture. Vapor pressure elevation can be seen for FC/HC mixtures whereas the vapor pressure decreases for FC/FC mixture. c. Consequent values for boiling point for different concentrations of C₅F₁₂. Boiling point depression can be seen for FC/HC mixture whereas it increases for FC/FC mixture. d. Empirical relation between the boiling point and the critical temperature of various straight chain fluorocarbons from perfluoromethane (bp 145 K) to perlfuorodecane (bp 417 K).

FIG. 7: Binary Phase Diagram for C₅F₁₂/C₁₄H₃₈ mixture. Upper critical solution temperature of >600° C. is seen for C₅F₁₂/C₁₈H₃₈ mixture. At any temperature below that, the mixture separates into two phases.

FIG. 8: Comparing vaporization temperatures with o-d transition temperatures and rotator phases. a. Plot showing the melting point (black solid squares), o-d transition temperature (black blank circles) and the vaporization temperature of endoskeletal droplets (red filled triangles with error bars denoting one standard deviation). Vaporization is predominant in the rotator phase range. b. A plot showing a fitted curve to the data from a single vaporization run from droplets made of C₅F₁₂/C₂₂H₄₆. σ is the standard deviation which represents the temperature range over which majority of the vaporization takes place. c. Plot comparing rotator phase temperature range (range of temperature over which the rotator phase lasts) for pure HC and the vaporization temperature range for droplets made with FC and that pure HC. Notice similar trends in the rise and fall in the temperature range. d. Similar plot comparing rotator phase temperature range for mixture of HC and the vaporization temperature range for droplets made with FC the same mixture of HC (filled red circles represents endoskeletal droplets made with C₅F₁₂ and C₂₂H₄₆/C₂₄H₅₀ mixture, filled black squares represents endoskeletal droplets made with C₅F₁₂ and C₂₀H₄₂/C₂₂H₅₆ mixture, empty circles and squares are for HC mixtures only).

FIG. 9: Fabrication of droplets. a. Microfluidic device design to make endoskeletal and exoskeletal droplets. b. Zoomed view of the junction area of the device. c. actual device attached to the glass slide sitting on top of a heater. You can see the tubes attached to the inlets and outlets.

FIG. 10: Uniform droplet utilizing varying formulations. In this embodiment, the present inventors melt the solid component individually by itself. The droplets are then cooled to obtain the solid structure. a. view of uniform droplet compositions, b. close-up view of uniform droplet compositions.

FIG. 11: Screen capture of video showing rotating droplet compositions. The image demonstrates that C₅F₁₂/C₁₂F₂₆ droplets have a disk-like solid structure inside, which is free to rotate when agitated;

FIG. 12: Screen capture of video puck formation. The image demonstrates formation of the solid disks when a heated liquid droplet is cooled through the transition. The formation of the solid disk is not gradual. Instead, the spherical droplets morph into a non-spherical shape for a while and snap back again into a spherical shape with a solid inside.

FIG. 13: Screen capture of video vaporization of FC heavy droplet. The image demonstrates vaporization of a single droplet. The endoskeletal droplet shown here consists of C₅F₁₂/C₂₀H₄₂ and is stabilized by lipid solution. This spherical droplet contains predominantly C₅F₁₂ and hence is spherical and sedimentary. The structure inside is the solid HC. The droplet formation is sudden and relatively forms a very large vapor bubble owing to the higher amount of volatile component present.

FIG. 14: Screen capture of video vaporization of HC heavy droplet. The image demonstrates vaporization of a single endoskeletal droplet. The droplet shown here consists of C₅F₁₂/C₂₀H₄₂ and is stabilized by the hydrocarbon lipid surfactant. The non-spherical droplet contains predominantly C₂₀H₄₂ and hence is non-spherical and buoyant. The droplet formation in this case is slow and forms a relatively small vapor bubble owing to the lower amount of volatile component present. As the medium is continually heated, the solid phase melts and forms a lens around the vapor cavity.

FIG. 15: Screen capture of video optical vaporization. The image demonstrates optical microscopy observation of vaporizing C₅F₁₂/C₂₂H₄₆ droplets while the sample is being heated. The scale bar is 100 μm.

FIG. 16: Screen capture of video ultrasound vaporization. The image demonstrates ultrasound B-mode imaging observation of vaporizing C₅F₁₂/C₂₀H₄₂ droplets while the sample is being heated. The bright circular region is the tube wall, and the bright horizontal line below the tube is the thermocouple. The sample is flowing in the tube. The crosshair on the left of the tube denotes the depth where the ultrasound is focused.

### DETAILED DESCRIPTION OF THE INVENTION(S)

One embodiment of the invention includes novel micron sized vaporizable droplets that can either have a solid core (endoskeleton) or a solid shell (exoskeleton) that help in either stabilizing or destabilizing the droplet against vaporization. In one preferred embodiment of the invention, the vaporizable droplets may include perfluorocarbon (PFC) droplets with either a PFC solid or a hydrocarbon (HC) solid. Using the PFC solid generates novel endoskeletal droplets structures which may include a liquid droplet with a solid “disk like” solid enclosed inside. Using PFC solid also stabilizes the PFC liquid against vaporization such that it can be heated to a very high temperature without vaporization. In another embodiment of the invention, the vaporizable droplets may include HC solid which may form either an endoskeletal shell, or an exoskeletal shell. Furthermore, using a HC solid destabilizes the PFC liquid and makes it vaporize at a lower temperature.

In another embodiment of the invention, the present inventors have demonstrated tunability in the vaporization temperature of vaporizable droplets having a solid exoskeleton or endoskeleton shell that induces changes in the vaporization temperature of the droplet. In another embodiment of the invention, the vaporization temperature of the droplet may be varied based on the type of solid used to generate the solid exoskeleton or endoskeleton shell.

In another embodiment of the invention, the present inventors have demonstrated tunability in the vaporization temperature of perfluoropentane droplets having a solid exoskeleton or endoskeleton shell that induces changes in the vaporization temperature of the perfluoropentane droplet. In another embodiment of the invention, the vaporization temperature of the perfluoropentane droplet may be varied based on the type of solid used to generate the solid exoskeleton or endoskeleton shell.

Another embodiment of the invention includes a novel approach to controlling vaporization behavior of droplets by using an endoskeleton that can melt and blend into the liquid core to either enhance or disrupt cohesive molecular forces. In one preferred embodiment, this method of controlling vaporization behavior of droplets may include the generation of perfluoropentane (C₅F₁₂) droplets encapsulating a fluorocarbon (FC) or hydrocarbon (HC) endoskeleton. In this embodiment, the molecular interactions between the endoskeleton and droplet phase may be tuned for achieving useful vaporization, or possibly other secondary phase transitions, in emulsions among other application.

The results of the present inventors studies into the use of solid endoskeletal and exoskeletal architecture to manipulate the vaporization of droplets was unexpected, and taught away from the current stat of the art. Indeed, two specific aspects were completely counterintuitive to the field of droplets vaporization. First, in the endoskeletal droplets made from perfluoropentane (C₅F₁₂) as the liquid and perfluorododecane as the solid, the present inventors expected to see heterogeneous nucleation because of the solid/liquid interface inside the droplet. But instead, this mixture made perfluoropentane (C₅F₁₂) more stable against vaporization as vaporization was not observed even at high temperatures. Second, in the endoskeletal/exoskeletal droplets made from perfluoropentane (C₅F₁₂) as the liquid and different hydrocarbons (HCs) (straight chain alkanes from carbon chain length 18-24 in one embodiment) as the solid, the present inventors again expected to see heterogeneous nucleation and vaporization of perfluoropentane at a lower temperature. But, although vaporization was observed at a lower temperature, that vaporization was induced by the melting transition of the HC instead of heterogeneous nucleation. If it was heterogeneous nucleation alone then no matter what HC was used, it should have vaporized at a constant temperature. But the present inventors found that perfluoropentane was consistently vaporizing at temperatures very close to the melting point of the HC used. So, the solid to liquid transition of the solid HC was initiating the liquid to vapor transition in perfluoropentane. Hence, using different HC the present inventors may “tune” the temperature at which perfluoropentane vaporized.

These endoskeletal FC droplets with FC or HC solid endoskeletal cores thus provide a new method of controlling thermal stability for new and existing applications of emulsion droplet vaporization. Use of the low-χ FC endoskeleton stabilizes the liquid phase, whereas the high-χ HC endoskeleton facilitates vaporization. For the latter, nucleation of the vapor phase may occur at the FC/HC interface after the solid ordered HC phase transitions to the solid disordered rotator phase. The synthesis method is relatively simple, and the mechanisms described are robust and independent of the surfactant types used in this invention. The principle of interfacial mixing, manipulating intermolecular forces and tuning the spinodal can be broadly applied to various materials, well beyond the initial demonstrations described here. Droplets that do not rely on heterogeneous nucleation could be used, for example, for improving cancer detection, delivering drugs and genes, aiding microfluidic mixing, detecting subatomic particles, or initiating reaction schemes in temperature-sensitive microreactors. Moreover, the linear dependence on melting point and the acoustic imaging capability of the post-vaporization bubbles could also be exploited as a means for a non-destructive in situ thermal probe in high scattering media. The ability to tune the thermodynamic limit of stability for endoskeletal emulsions by interfacial mixing will likely find abundant applications.

As noted above, in one embodiment, the present inventors generated perfluoropentane (C₅F₁₂) droplets as the vaporizable species. Perfluorocarbons are biologically inert materials with relatively high vapor pressure. The presence of one of the strongest intramolecular covalent bonds (C—F) makes it inert to biological and atmospheric processes, volatile owing to weak intermolecular forces, and especially hydrophobic. FCs have thus been used for blood expansion, acoustic droplet vaporization and detection of high-energy particles. Recent research on biomedical acoustic droplet vaporization has focused on highly volatile species, such as perfluoropropane (C₃F₈) and perfluorobutane (C₄F₁₀), to achieve a spinodal near physiological temperature, but these lighter fluorocarbons are more water soluble and therefore rapidly clear from circulation, which limits their utility. Replacing C₄F₁₀ with C₅F₁₂ may significantly increase the circulation persistence. but the latter can be difficult to vaporize. Owing to the higher spinodal of C₅F₁₂ and accompanying large mechanical index for acoustic droplet vaporization, researchers have focused on heterogeneous nucleation by nanoparticle inclusions as a mechanism to effect vaporization. Research by the present inventors was inspired by this approach, as well as recent work on HC/HC endoskeletal droplets, in which a liquid droplet encapsulates a solid phase. The solid phase provides elasticity to enable nonspherical shapes, and we initially hypothesized that it may also serve as a surface for, however the results were.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described.

Non-limiting examples of suitable perfluorocarbons for use in invention may include perfluoroalkanes such as perfluoropentane, perfluorohexane, perfluorononane, perfluorohexyl bromide, perfluorooctyl bromide, and perfluorodecyl bromide; perfluoroalkyl ethers; perfluoroalkenes such as bisperfluorobutylethylene; perfluorocycloalkanes such as perfluorodecalin, perfluorocyclohexanes, perfluoroadamantane, perfluorobicyclodecane, and perfluoromethyl decahydroquinoline; perfluoro amines such as perfluoroalkyl amines; and C1-C8 substituted compounds thereof, isomers thereof, and combinations thereof.

The term “droplet” as used herein refers to an amount of liquid that is encased or surrounded by a different, enclosing substance. Droplets that are less than one micrometer in size are commonly referred to as “nanodroplets” and those that are in the one micrometer to tens or hundreds of micrometers in size are commonly referred to as “microdroplets.” If a droplet is encased in another liquid, the droplet and its casing may also be referred to as an “emulsion” or a “droplet emulsion.” An emulsion is a mixture of two immiscible liquids. Emulsions are colloids wherein both phases of the colloid (i.e., the dispersed phase and the continuous phase) are liquids and one liquid (the dispersed phase or encapsulated material) is dispersed/encapsulated in the other liquid (the continuous phase or encapsulating material). The encapsulating material can include a lipid, protein, polymer, gel, surfactant, peptide, or sugar, as is known in the art.

The average diameter of a droplet, such as a PFC droplet having FC or HC endoskeletal or exoskeletal shells for use methods of the disclosure are contemplated to be between from about 0.1 μm to about 600 μm. In further embodiments, the average diameter of a droplet is from about 20 μm to about 600 μm. The average droplet diameter and droplet size distribution can be determined using various techniques known in the art, such as optical microscopy, Coulter counter, and light scattering. Different droplet diameters can be obtained by varying the surfactant concentration or the amount of shear force applied to generate the primary or secondary emulsions. In various embodiments, the diameter of a PFC droplet is from about 0.1 μm to about 500 μm, or from about 0.1 μm to about 400 μm, or from about 0.1 μm to about 300 μm, or from about 0.1 μm to about 200 μm, or from about 0.1 μm to about 100 μm, or from about 1 μm to about 500 μm, or from about 1 μm to about 400 μm, or from about 1 μm to about 300 μm, or from about 1 μm to about 200 μm, or from about 1 μm to about 100 μm, or from about 10 μm to about 500 μm, or from about 10 μm to about 400 μm, or from about 10 μm to about 300 μm, or from about 10 μm to about 200 μm, or from about 10 μm to about 100 μm, or from about 50 μm to about 500 μm, or from about 50 μm to about 400 μm, or from about 50 μm to about 300 μm, or from about 50 μm to about 200 μm, or from about 50 μm to about 100 μm. In further embodiments, the diameter of a PFC droplet is from about 0.1 μm to about 50 μm, or from about 0.1 μm to about 75 μm, or from 0.1 μm to about 100 μm, or from 0.1 μm to about 200 μm, or from about 0.1 μm to about 300 μm, or from about 20 μm to about 50 μm, or from about 20 μm to about 75 μm, or from 20 μm to about 100 μm, or from 20 μm to about 200 μm, or from about 20 μm to about 300 μm. In yet further embodiments the diameter of a PFC droplet is from about 0.1 μm and up to about 10 μm, 20 μm, 25 μm, 30 μm, 35 μm, 40 μm, 45 μm, 50 μm, 55 μm or 60 μm. In additional embodiments, the diameter of a PFC droplet is from about 100 μm and up to about 150 μm, 200 μm, 250 μm, 300 μm, 350 μm, 400 μm, 450 μm, 500 μm, 550 μm or 600 μm. In specific embodiments, the diameter of a PFC droplet is about 0.1 μm, 0.2 μm, 0.3 μm, 0.4 μm, 0.5 μm, 0.6 μm, 0.7 μm, 0.8 μm, 0.9 μm, 1μm, 1.5 μm, 2μm, 5μm, 10 μm, 15 μm, 20 μm, 50 μm, 100 μm, about 110 μm, about 120 μm, about 130 μm, about 140 μm, about 150 μm, about 160 μm, about 170 μm, about 180 μm, about 190 μm, about 200 μm, about 210 μm, about 220 μm, about 230 μm, about 240 μm, about 250 μm, about 260 μm, about 270 μm, about 280 μm, about 290 μm, about 300 μm, about 310 μm, about 320 μm, about 330 μm, about 340 μm, about 350 μm, about 360 μm, about 370 μm, about 380 μm, about 390 μm, about 400 μm, about 410 μm, about 420 μm, about 430 μm, about 440 μm, about 450 μm, about 460 μm, about 470 μm, about 480 μm, about 490 μm, about 500 μm, about 510 μm, about 520 μm, about 530 μm, about 540 μm, about 550 μm, about 560 μm, about 570 μm, about 580 μm, about 590 μm, about 600 μm or more.

In still further embodiments, the diameter of a PFC droplet is at least 0.1 μm, at least 0.2 μm, at least 0.3 μm, at least 0.4 μm, at least 0.5 μm, at least 0.6 μm, at least 0.7 μm, at least 0.8 μm, at least 0.9 μm, at least 1 μm, at least 1.5 μm, at least 2 μm, at least 5 μm, at least 10 μm, at least 15 μm, at least 20 μm, at least 50 μm, at least 100 μm, at least 110 μm, at least 120 μm, at least 130 μm, at least 140 μm, at least 150 μm, at least 160 μm, at least 170 μm, at least 180 μm, at least 190 μm, at least 200 μm, at least 210 μm, at least 220 μm, at least 230 μm, at least 240 μm, at least 250 μm, at least 260 μm, at least 270 μm, at least 280 μm, at least 290 μm, at least 300 μm, at least 310 μm, at least 320 μm, at least 330 μm, at least 340 μm, at least 350 μm, at least 360 μm, at least 370 μm, at least 380 μm, at least 390 μm, at least 400 μm, at least 410 μm, at least 420 μm, at least 430 μm, at least 440 μm, at least 450 μm, at least 460 μm, at least 470 μm, at least 480 μm, at least 490 μm, at least 500 μm, at least 510 μm, at least 520 μm, at least 530 μm, at least 540 μm, at least 550 μm, at least 560 μm, at least 570 μm, at least 580 μm, at least 590 μm, at least 600 μm or more.

Although some embodiments of the invention a PFC droplet can consist essentially of a dispersed perfluorocarbon and a continuous liquid phase encapsulating material (and optionally an emulsion stabilizer), other additives can be optionally included. Suitable additives for the perfluorocarbon droplet emulsions can include, but are not limited to, hydrogels, anti-oxidants, sequestering agents, chelating agents, steroids, anti-coagulants, drugs, carriers, solvents, preservatives, surfactants, wetting agents, and combinations thereof. A perfluorocarbon droplet can also include excipients such as solubility-altering agents (e.g. ethanol, propylene glycol, and sucrose) and polymers (e.g. polycaprylactones and PLGA's), as well as pharmaceutically active compounds.

As used herein and in the appended claims, the singular forms “a”, “and”, and “the” include plural referents unless the context clearly dictates otherwise. Thus, for example, reference to “a compound” includes a plurality of such compounds, and reference to “the method” includes reference to one or more methods, method steps, and equivalents thereof known to those skilled in the art, and so forth.

The invention now being generally described will be more readily understood by reference to the following examples, which are included merely for the purposes of illustration of certain aspects of the embodiments of the present invention. The examples are not intended to limit the invention, as one of skill in the art would recognize from the above teachings and the following examples that other techniques and methods can satisfy the claims and can be employed without departing from the scope of the claimed invention.

### EXAMPLES

### Example 1: Heterogeneous Nucleation in C₅F¹² Droplets Using Novel Endoskeletal Architecture with Perfluorododecane (C₁₂F₂₆) as the Solid Component

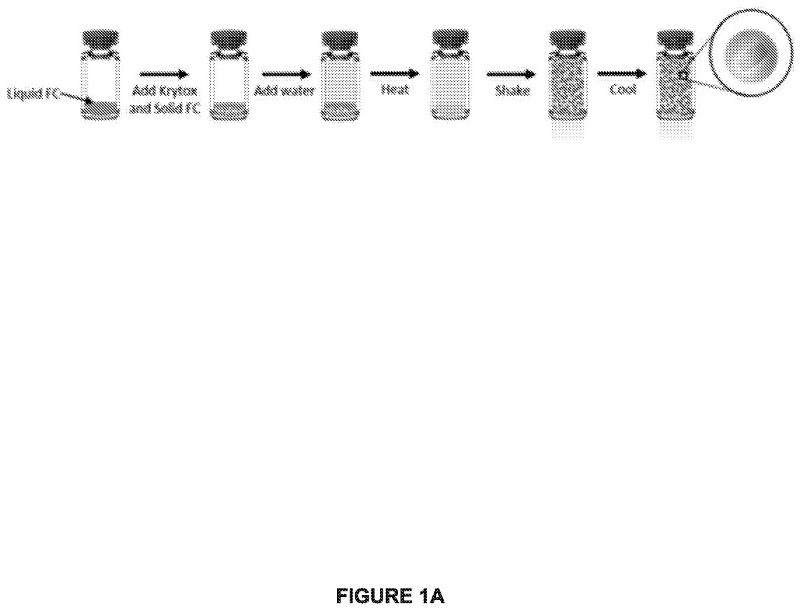

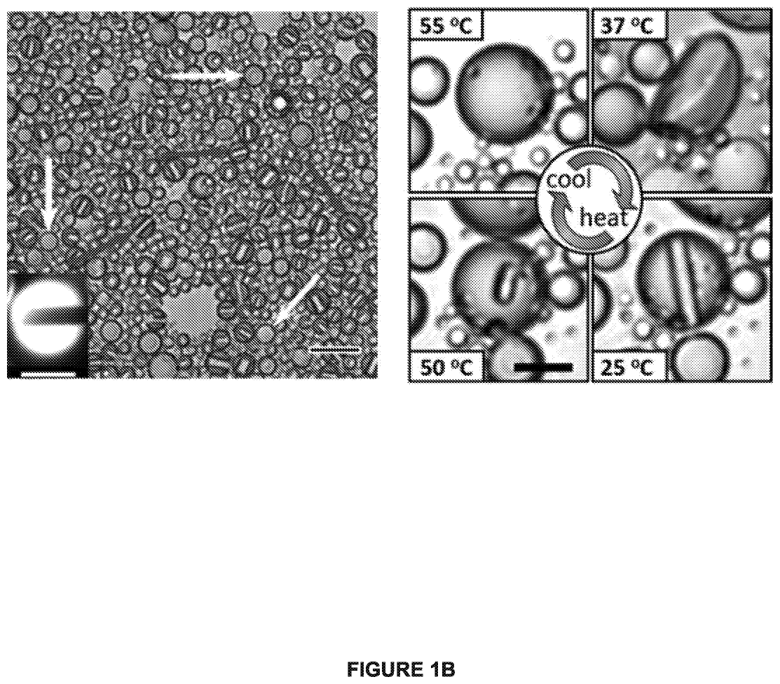

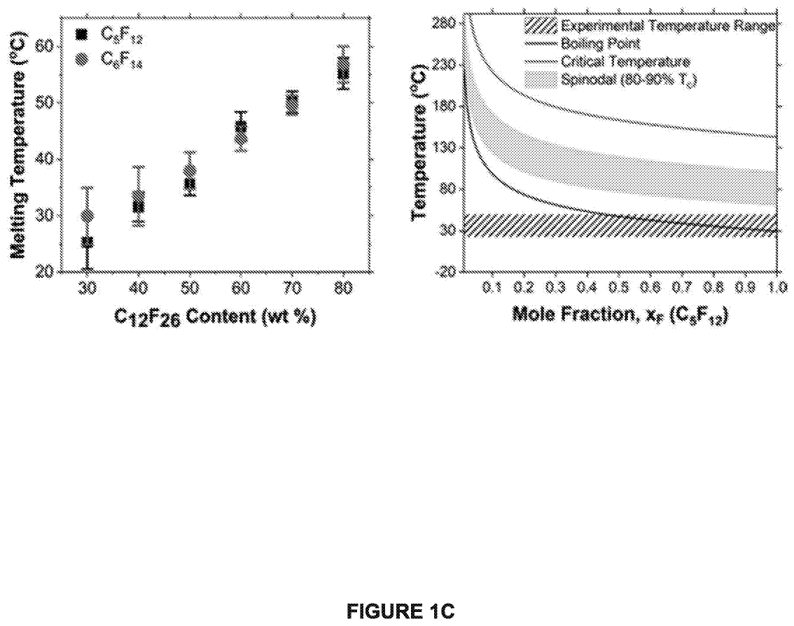

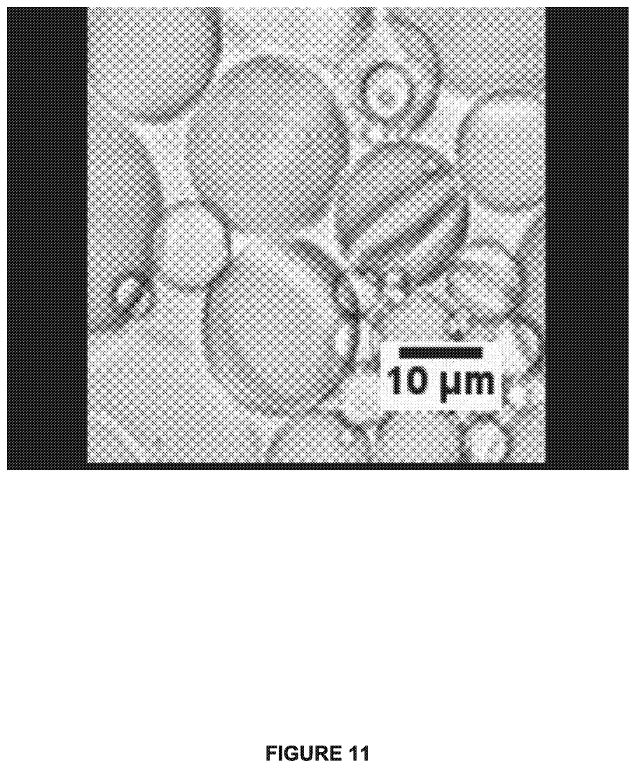

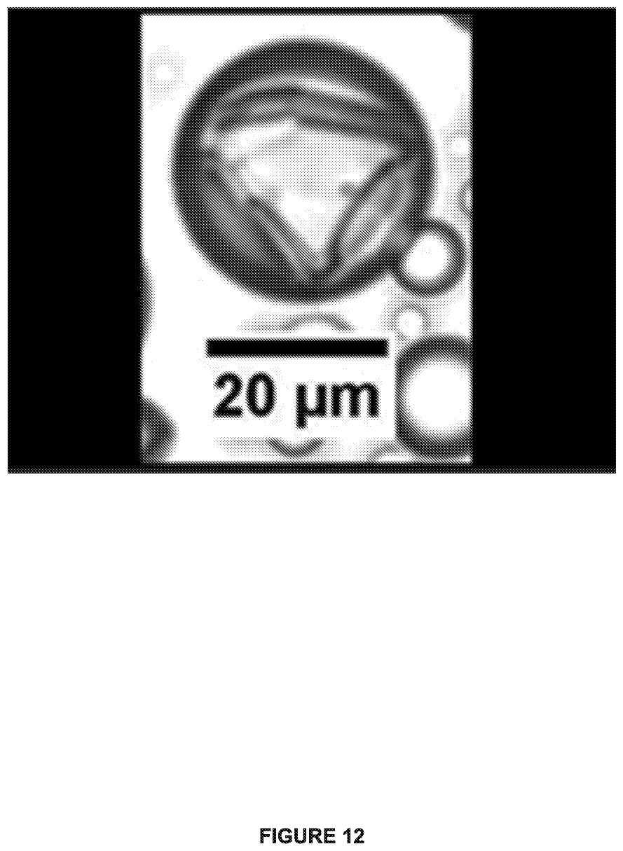

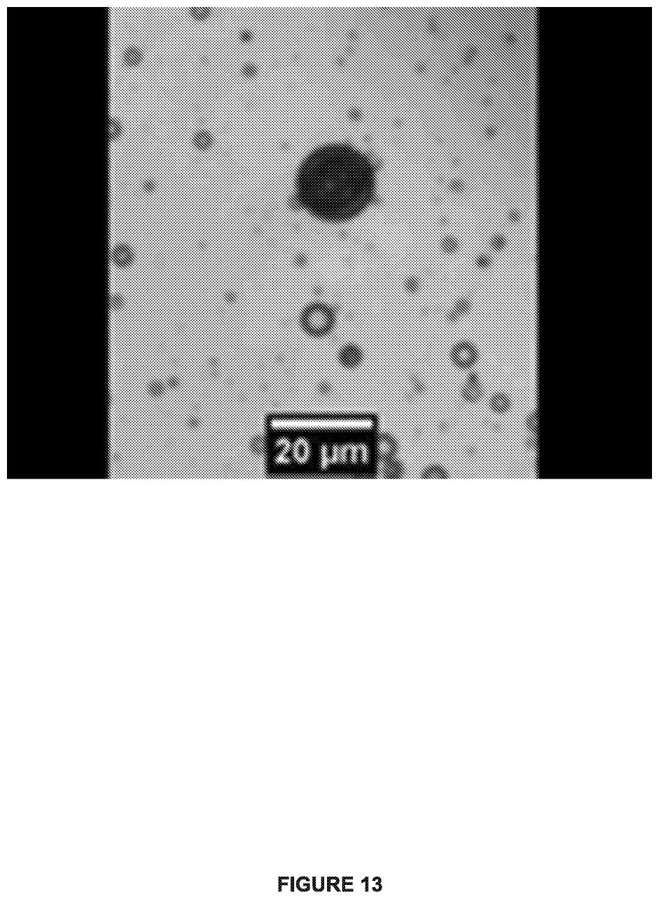

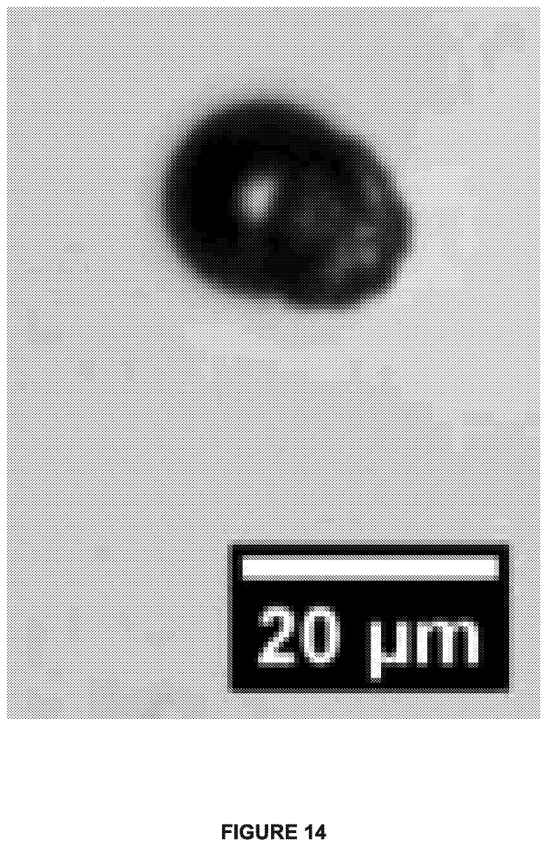

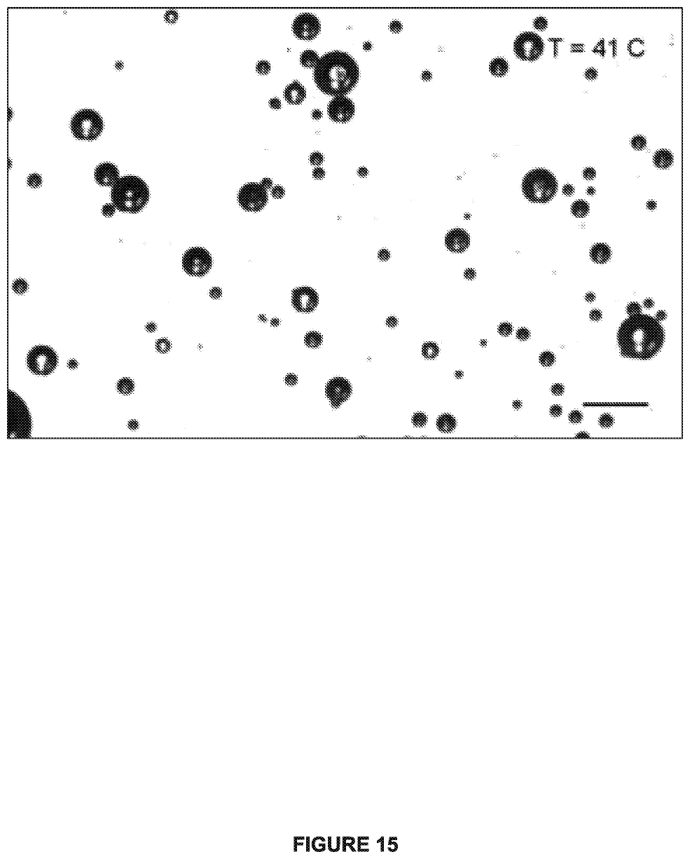

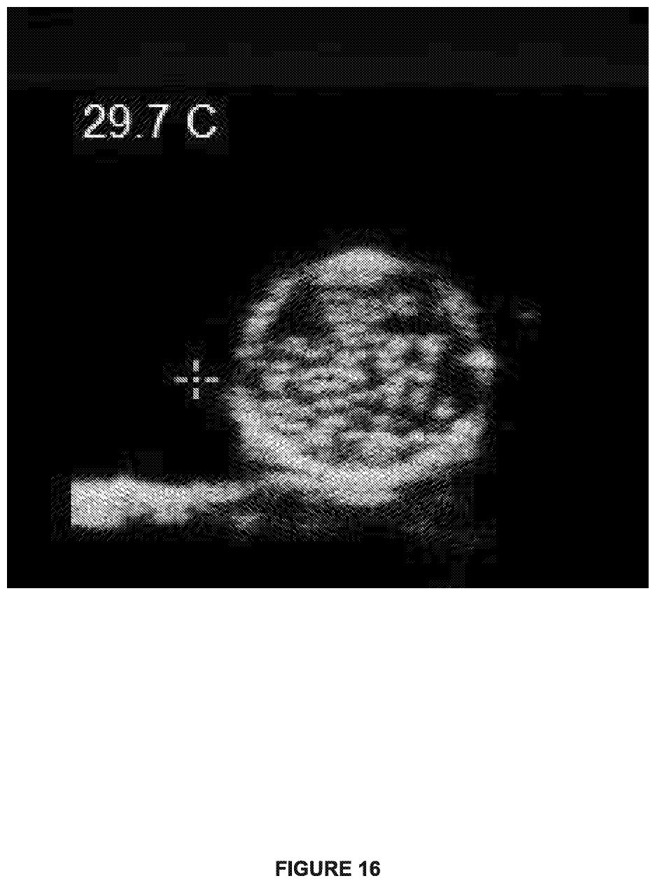

To explore the feasibility of heterogeneous nucleation in C₅F₁₂ droplets, the present inventors designed a novel endoskeletal architecture with perfluorododecane (C₁₂F₂₆) as the solid component. Although solid C₁₂F₂₆ melts at a higher temperature (75° C.) than the boiling point of C₅F₁₂ (29° C.) (Table 1), a liquid mixture of the two species was obtained over a limited temperature range (30-65° C. for 30-80wt % C₁₂F₂₆). The C₅F₁₂/C₁₂F₂₆ liquid mixture was emulsified and then cooled to generate novel endoskeletal droplets, which contained solid disk structures (FIGS. 1a, 1b). The droplets were 3.25±2.28 μm in diameter, and their morphology was uniform. Increasing C₁₂F₂₆ content increased the relative disk size. The disks were observed to rotate inside the droplets when disturbed by fluid flow (FIG. 11). Interestingly, disk formation was not gradual; as the droplet cooled, it buckled to a nonspherical shape with an internal network structure and then snapped back into a spherical shape with a smooth disk inside (FIG. 1c, FIG. 12). The disk-in-sphere geometry was the stable structure for FC/FC endoskeletal droplets.

### Example 2: Phase Transition Behavior of Novel Endoskeletal Droplets

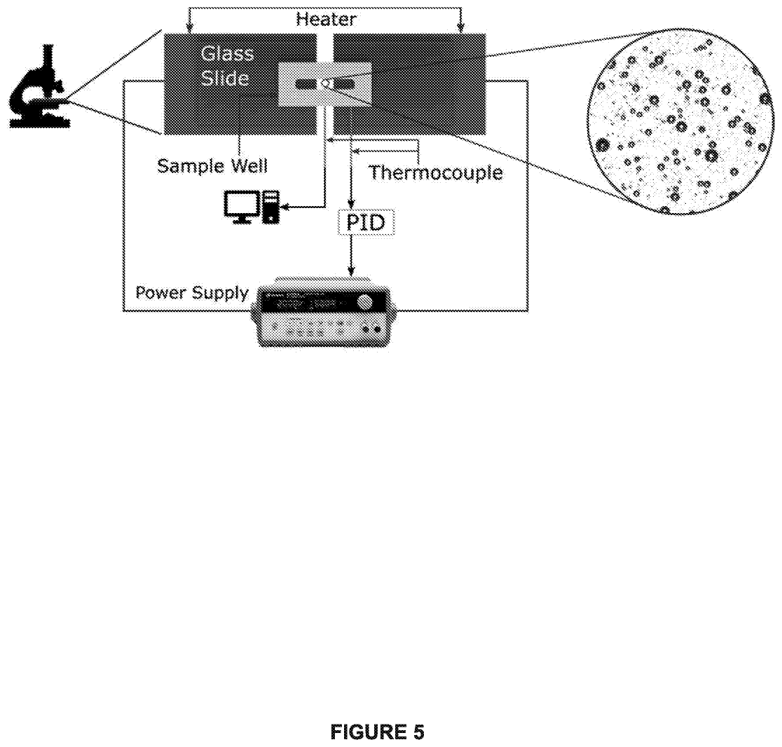

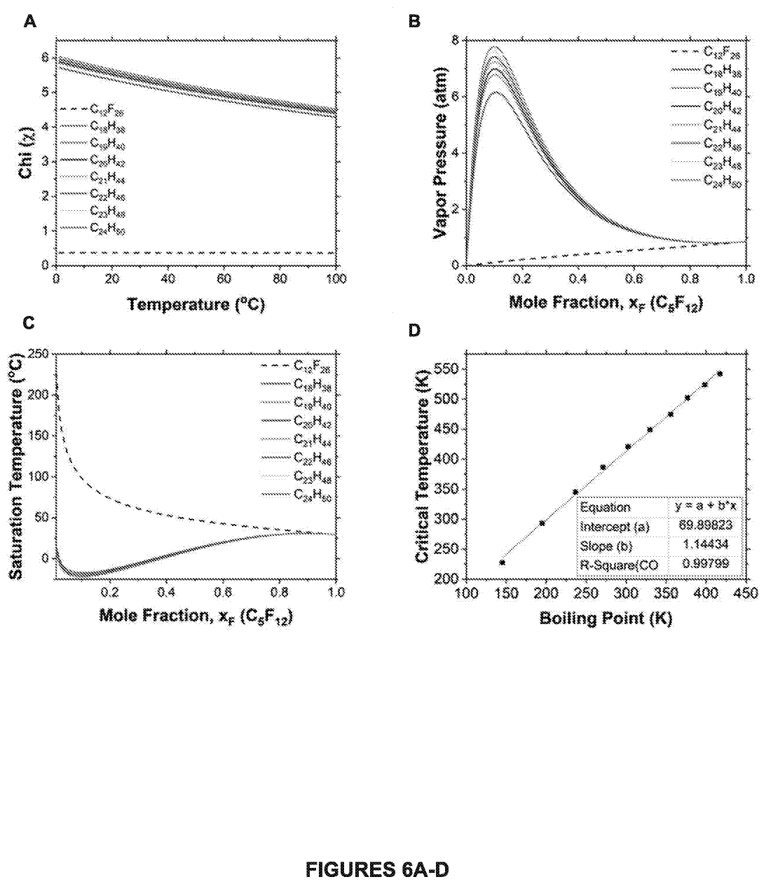

To examine the phase transition behavior of these novel endoskeletal droplets, they were monitored while being gradually heated (FIG. 5). However, heating these droplets to the boiling point of C₅F₁₂ (29° C.) did not lead to vaporization, as would be expected for heterogeneous nucleation. Instead, the solid disks gradually melted at a temperature (Tₘ) that depended on the ratio of C₁₂F₂₆ to C₅F₁₂ (FIG. 1d). The Tₘ was found to increase with increasing C₂F₂₆ solid content, but it was always lower than the melting point of pure C₁₂F₂₆. This experiment was repeated with perfluorohexane (C₆F₁₄) as the volatile species, with similar results. Moreover, these droplets did not vaporize, even when heated up to 75° C. The vaporization temperature of a liquid is determined by intermolecular interactions between the constituent molecules. This effect can be captured quantitatively in a mixture by the exchange parameter (χ), which describes the excess free energy of mixing and includes both enthalpic and entropic contributions. In general, χ has a low value for chemically similar blends and a large value for blends that demix easily. In the case of C₅F₁₂/C₁₂F₂₆ droplets, C₅F₁₂ is a good solvent for C₁₂F₂₆ (FIG. 6) with a low χ value of 0.37. Hence, the boiling point, critical temperature and spinodal of C₅F₁₂ increases in the presence of C₁₂F₂₆ (FIG. 1e), which suppresses vaporization. The use of low-χ endoskeletal melting to enhance cohesion and avoid vaporization may be an important strategy for certain applications, such as thermal energy storage.

### Example 3: Novel Vaporizable Droplets Using HC as the Solid Component

Using the same logic to design readily vaporizable droplets, the present inventors chose to use HCs (alkanes with carbon chain length of 18 to 24) instead of FCs as the solid phase. HCs and FCs do not mix well, as evidenced by their high χ values (5.3 for C₅F₁₂/C₁₈H₃₈ mixture to 5.6 for C₅F₁₂/C₂₄H₅₀ mixture at room temperature).

### Example 4: Novel Mixed Vaporizable Droplets Using FC and HC as the Solid Component

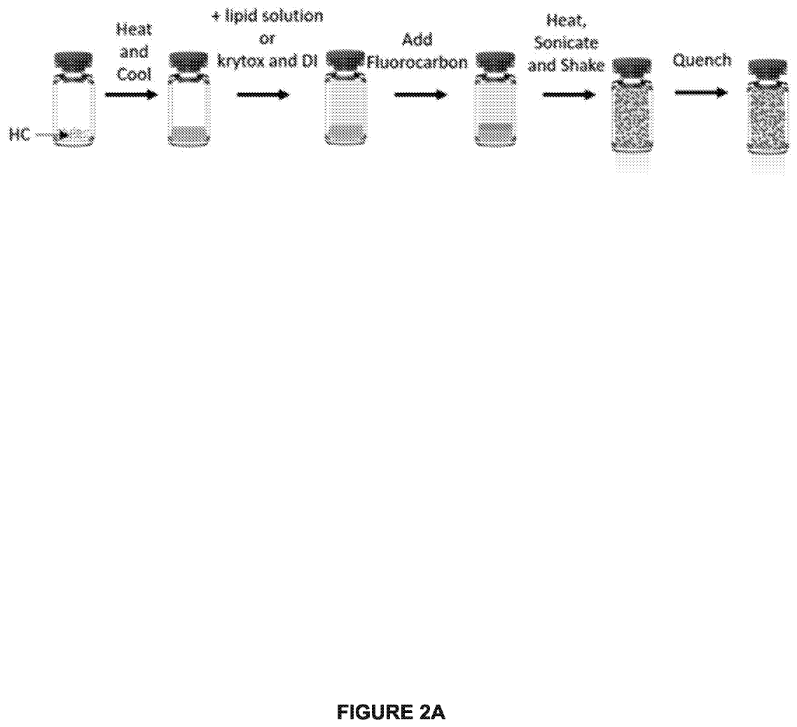

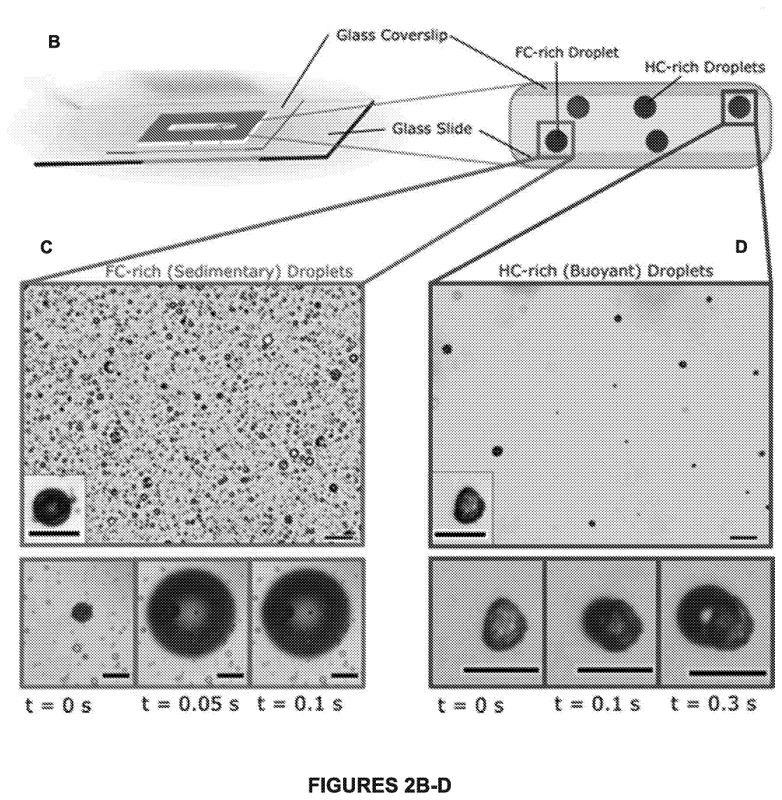

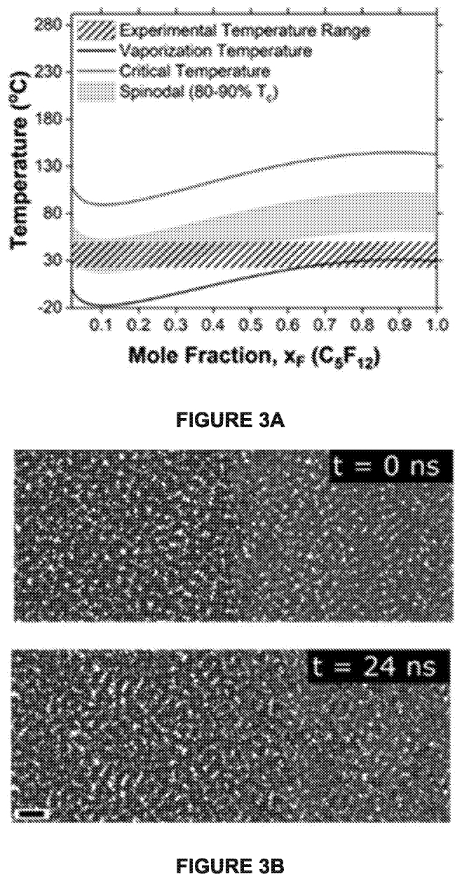

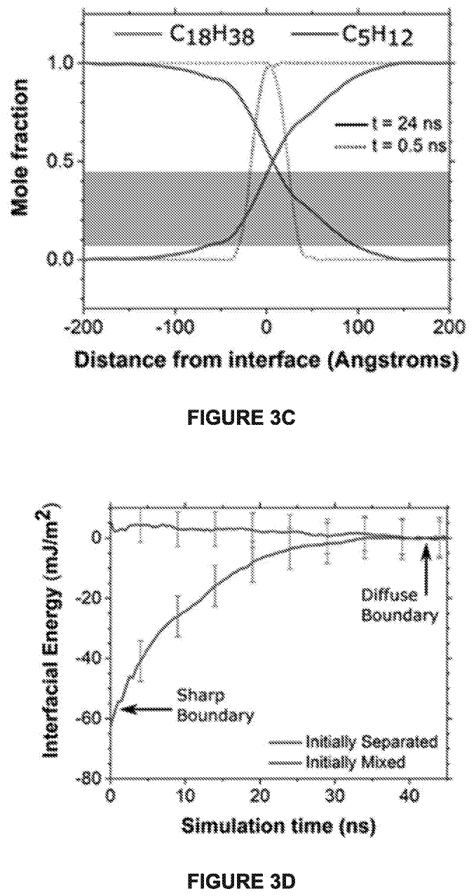

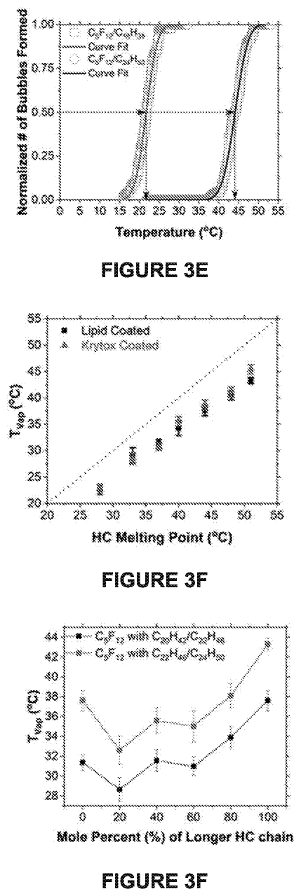

Base on prior data, the present inventors hypothesized that the disruption of FC-FC interactions due to the presence of HC would enable C₅F₁₂ vaporization near physiological temperature. FC/HC endoskeletal droplets comprising liquid C₅F₁₂ and solid C₁₈H₃₈ were prepared in a similar way as the FC/FC droplets (FIG. 2a). However, these droplets had a bimodal morphology owing to differences in HC content. HC-rich droplets were non-spherical and buoyant, whereas FC-rich droplets were spherical and sank to the bottom (FIGS. 2b-c). Vaporization was observed in both droplet types at a similar temperature (−22° C.), which was lower than the boiling point of pure C₅F₁₂ (FIG. 2c-d). This observation supported the theoretical prediction that high-χ endoskeletal melting aids in vaporization. In this system, the spinodal is predicted to occur near physiological temperature for C₅F₁₂ concentrations between 5 and 40 mole % in the HC-rich phase (FIG. 3a).

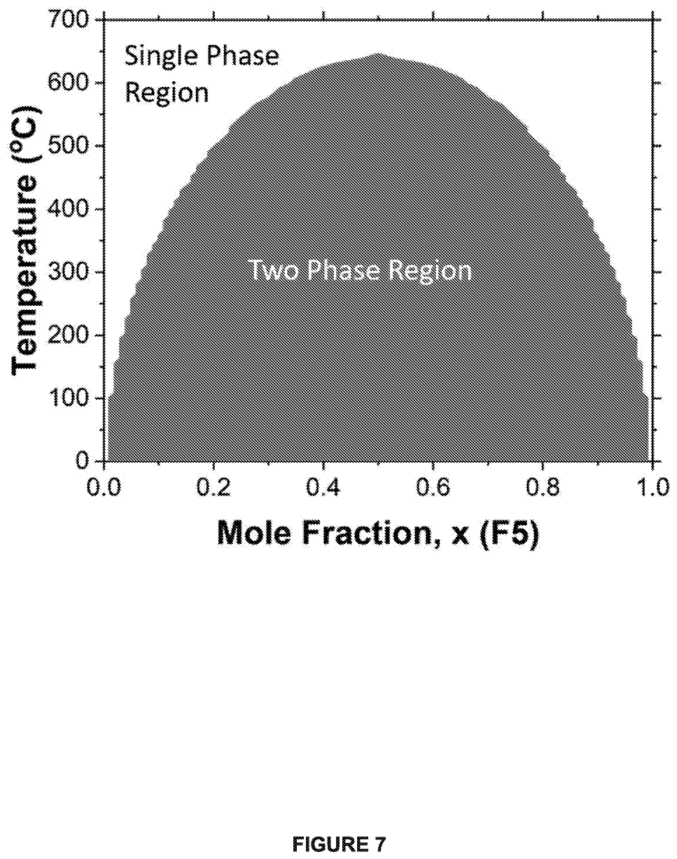

Although the bulk HC and FC liquid phases are immiscible (FIG. 7), the interfacial region between them is sufficiently diffuse to allow FC/HC mixing. This was shown with molecular dynamics (MD) simulations performed on C₁₈H₃₈ and C₅F₁₂. The interfacial layer between FC and HC grows to an extension of approximately 10 nm in both directions during the simulation time and then expands no further (FIGS. 3b-c). The interfacial energy increases by about +30 mJ/m² upon mixing in the interfacial region from a sharp interface to a diffuse interface, driven by Brownian motion of the molecules (FIG. 3d). Reduced cohesion after mixing is qualitatively consistent with depression of the vaporization point of C₅F₁₂ observed in our experiments. The formation of a diffuse interface concurs with recent experimental observations of diffuse phase boundaries in atomic resolution. Prior studies of nucleation and growth have indicated typical initial nucleus sizes of just a few nanometers, and the availability of a region of reduced cohesion in excess of 10 nm at the interface of between C₁₈H₃₈ and C₅F₁₂ supports, in principle, the development of gas bubbles of C₅F₁₂. The time scale of milliseconds for bubble formation in experiments (FIGS. 2c-d) is consistent with a time scale of nanoseconds to microseconds to reform depleted interfaces according to the MD simulation (FIGS. 3b-d).

### Example 5: High-χ Endoskeletal Melting Effect on Vaporization

The robustness of the high-χ endoskeletal melting effect on vaporization was demonstrated experimentally over a homologous series of HC species. Here, the vaporization temperature (Tᵥₐₚ) was defined as the point at which 50% of the droplets vaporized (FIG. 3e). Interestingly, the droplets were observed to vaporize slightly below the Tₘ of the pure HC phase (FIG. 3f), independent of the surfactant type (hydrocarbon lipid or fluorocarbon krytox) used. Long-chain HCs are known to transition from an ordered phase to a disordered ‘rotator’ phase (termed o-d transition) at temperatures below the actual melting point. These rotator phases are present in HC with carbon chain lengths of >7 for odds and >20 for evens. The o-d transition is characterized by the formation of kinks in the HC chains, which make the HC solid phase more liquid-like. The HC o-d transition temperatures correlate well with the present inventors experimental vaporization temperatures, indicating that the HC rotator phase facilitates mixing between HC and FC molecules and promotes droplet vaporization.

### Example 6: Effect of the HC o-d Transition on Droplet Vaporization

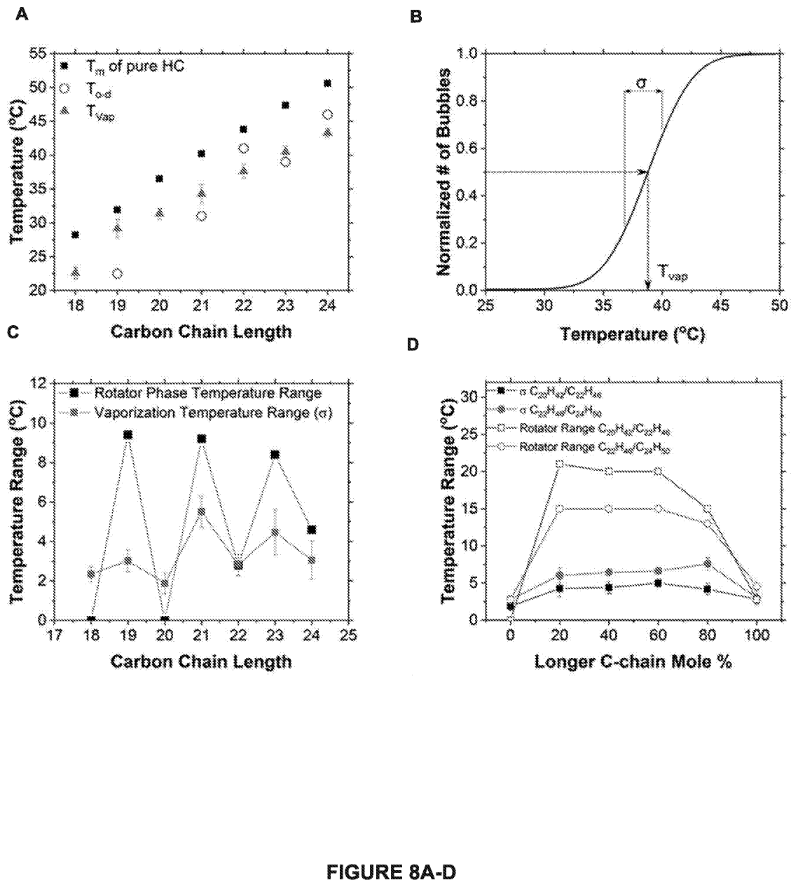

More evidence for the effect of the HC o-d transition on droplet vaporization was demonstrated with endoskeletons comprising the HC/HC mixtures eicosane/docosane (C₂₀H₄₂/C₂₂H₄₆) and docosane/tetracosane (C₂₂H₄₆/C₂₄H₅₀). Phase diagrams of these mixtures show a lowered o-d transition temperature for the mixtures than the pure components. Corresponding with the phase diagram, C₅F₁₂ endoskeletal droplets formulated with these HC mixtures exhibited a lower vaporization temperature than droplets made with pure components (FIG. 3g). In addition, the range of vaporization temperatures increased with the area of the rotator phase on the phase diagram (FIGS. 8c-d). These results support the concept that the o-d transition to the rotator phase in the solid HC phase is responsible for vaporization of the liquid FC phase.

### Example 7: Application of Clinical Ultrasound to Image Droplet Vaporization

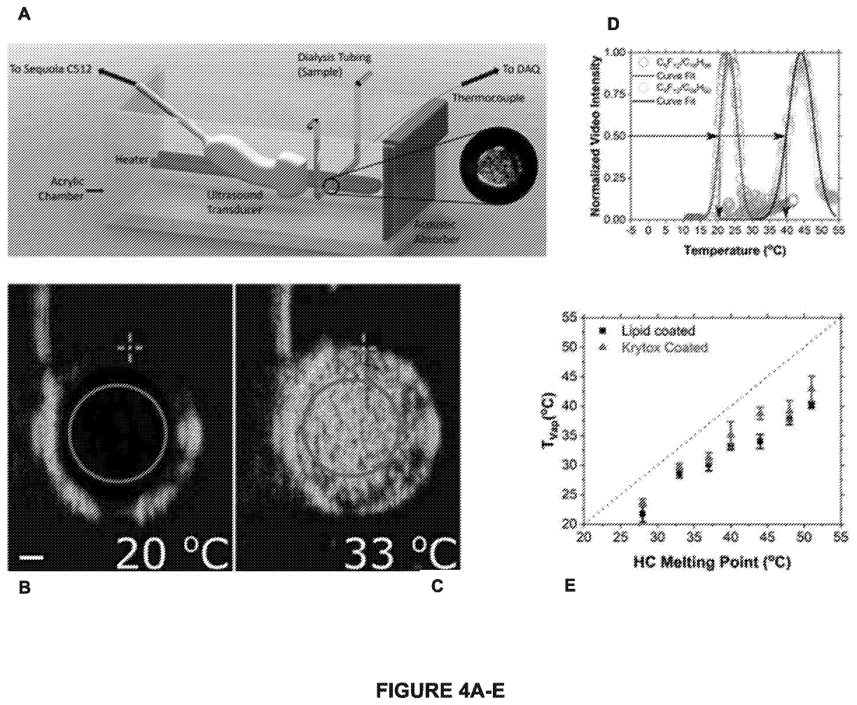

To demonstrate the utility of invention's droplets, the present inventors incorporated a clinical ultrasound scanner as an imaging source in order to observe vaporization. The endoskeletal droplets, made with C₅F₁₂ and pure HC, were diluted in water and held in an acoustically transparent dialysis tube. The tube was submerged in a water bath to act as an acoustic coupling and heated with an immersion heater (FIG. 4a). B-mode images showed the cross section of the tube before and after vaporization of the droplets, respectively (FIGS. 4b-c). The red circle denotes the region of interest (ROI) selected to calculate the video intensity, which was used to quantify vaporization. Following the optical experiments, endoskeletal droplets with different HC species were used with either hydrocarbon or fluorocarbon surfactants. Temperature at the 50% maximum intensity was taken as the vaporization temperature (FIG. 4d). The results mirrored those of the optical experiments: a linear relationship was observed between the droplet vaporization temperature and the melting point of the pure HC (FIG. 4e). The vaporization temperatures measured by ultrasound were slightly lower (˜2° C.) than those measured optically, likely due to acoustic effects.

### Example 8: Fabrication of Novel Droplet Compositions

A wide variety of approaches known in the art can be useful for preparing the perfluorocarbon droplet emulsion, including techniques such as sonication, agitation, mixing, high shear agitation, homogenization/atomization, and the like. An exemplary process for preparing the perfluorocarbon droplet emulsions can include causing the perfluorocarbon to condense into a liquid and then extruding or emulsifying the perfluorocarbon liquid into or in the presence of an encapsulating material to form a droplet emulsion comprising a dispersed liquid phase perfluorocarbon and a continuous liquid phase encapsulating material. To condense the perfluorocarbon, the perfluorocarbon may be cooled to a temperature below the phase transition temperature of the perfluorocarbon having the lowest boiling point, compressed to a pressure above the phase transition pressure of the perfluorocarbon having the highest phase transition pressure value, or a combination of the two. The contents of the perfluorocarbon droplet emulsion may be entirely or primarily in the liquid phase.

In one embodiment, the invention's novel droplets may be fabricated by the formation of an emulsion, typically done through physically disturbing components, such as by sonication, or by shaking with a generic dental amalgamator, or other common methods of making emulsions known in the art. In one embodiment, both the fluorocarbon and hydrocarbon are liquefied before making the droplets. This may be done in a closed system, such as a closed and sealed vial. Sealing the vial and then heating it causes the pressure inside to increase, which also causes the boiling point of the FC, which may be perfluoropentane, to also increase. This step may be beneficial in the formation of the invention's novel droplets as, in this preferred embodiment, the bulk boiling point of perfluoropentane is 29 C. whereas the exemplary solids don't melt until, for example: 28° C. (C₁₈H₃₈), 31° C. (C₁₉H₄₀), °36 (C₂₀H₄₂), °40 C. (C₂₁H₄₄), °43 C. (C₂₂H₄₆), °47 C. (C₂₃H₄₈), °50 C. (C₂₃H₅₀) and °75 C. (C₁₂F₂₆). A

[symbol]

Although increasing pressure increases both the boiling point as well as the melting point, the boiling point increase is faster and more prominent than the increase in the melting point of the solids which is much slower. So, by pressurizing the vial, the present inventors are able to liquefy the solids without vaporizing all the perfluoropentane liquid. In this embodiment, the droplets may further be cooled after emulsification to bring back the solid phase endoskeletal or exoskeletal architecture.

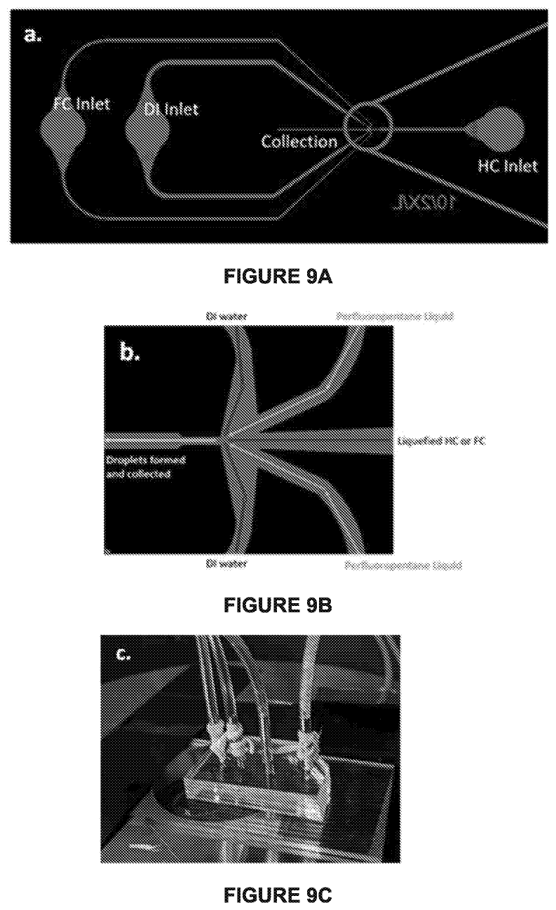

In one embodiment, the invention's novel droplets may be fabricated using microfluidics. In this embodiment, a device capable to executing a lab on a chip technique, such as small PDMS chip roughly 2.5×1.5×0.8 cm as seen in FIG. 9C, may be established having inlets for one or more aqueous medium, for example: (DI water), the liquid (Perfluoropentane) or melted solid phase (Fluorocarbon—FC or Hydrocarbon—HC). The various components may be pumped, manually and/or automatically into the established device. In this preferred embodiment, the solid FC or HC is melted first before being pumped into the device. This is done by using a heat lamp to heat a syringe that may be configured to manually or automatically pump the heated material into the device.

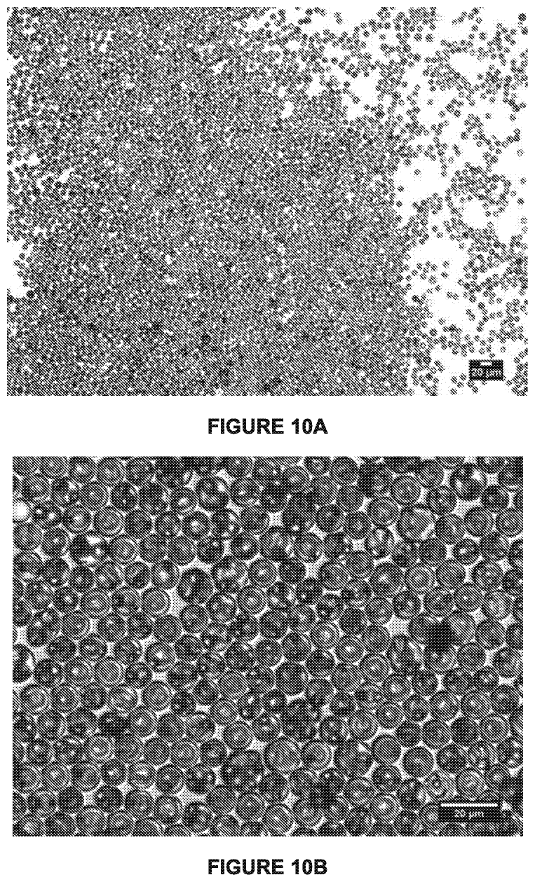

In another embodiment, the device may be bonded with a glass slide which sits on top of a flexible heater. This flexible heater may heats the HC inlet and does not heat the other parts of the device. Using this device, the present inventors have been able to make uniform droplets with endoskeletal or endoskeletal shells with different formulations as shown in FIG. 10A-B.

### Example 9: Data Analysis and Analytical Framework

### Theoretical Vaporization Behavior of Mixtures.

The boiling point of a liquid is defined as the temperature at which the vapor pressure equals the ambient pressure. In the presence of sites for heterogeneous nucleation, such as solid surfaces, vaporization occurs at the boiling point. In the absence of heterogeneous nucleation, vaporization occurs at a higher temperature, and the liquid becomes superheated. The thermodynamic limit for superheat is called the “spinodal”, and it occurs at approximately 80-90% of the critical temperature. Here we analyze the effects of FC/FC and FC/HC mixtures on the vapor pressure, boiling point and spinodal temperature. Boiling point elevation (or vapor pressure depression) in a binary mixture is a well-established phenomenon. The vapor pressure for a binary mixture can be estimated using the lattice model. According to the lattice mode, the vapor pressure of a volatile solvent (perfluorocarbon in our case) in a binary mixture at a specific temperature is given by,

Pᵥₐₚ=P₀x_{F}e^{x(1-x}^{_{F}}⁾^{²} (1)

where Pᵥₐₚ is the vapor pressure of the mixture, P₀ is the vapor pressure of the pure solvent, x_{F} is the mole fraction of the solvent and χ is the exchange parameter. The exchange parameter (χ) describes the excess free energy of mixing and includes both enthalpic and entropic contributions. It also dictates how ideal the mixture is. For ideal mixtures (χ=0), the vapor pressure increases linearly with solvent mole fraction and reaches a maximum for the pure solvent. For non-ideal mixtures, vapor pressure depends exponentially on the value of χ. The exchange parameter can be written as a sum of its entropic (χₛ) and enthalpic (χ_{H}) components,

χ=χ_{H}+χₛ (2)

The entropic component of the interaction parameter was set at 0.34 because the FC and HC species are nonpolar. The enthalpic component depends on temperature and the affinity of the two components. Hildebrand solubility parameters can be used to calculate the enthalpic contribution of χ using the following equation,

$${χ}_{H} = \frac{{{V}_{F} ( {δ}_{1} - {δ}_{2} )}^{2}}{R T} \qquad ( 3 )$$

where V_{F} is the molar volume of the solvent (perfluoropentane), δ₁ is the solubility parameter of the solvent, δ₂ is the solubility parameter of the solid component (either hydrocarbon or perfluorododecane), R is the universal gas constant and T is absolute temperature. The Hildebrand solubility parameter (δ) is a measure of the self-cohesiveness, and the compatibility of two components is quantified by the difference between these quantities. The quantity δ² is called the cohesive energy density (Ū₀) as it characterizes the strength of the attractions between the molecules. Similar molecules have similar values for δ. Hence mixing becomes more favorable as the difference between the solubility parameters of the two components decreases. In the case of perfluorocarbons⁸, δ for perfluoropentane is 11.3 MPa^{1/2} and perfluorododecane is 12 MPa^{1/2}. From the δ values of FC mixtures, it can be seen that these components favor mixing. For HC, the solubility parameter δ was calculated from its cohesive energy density (Ū₀). The cohesive energy density can be calculated using the molar cohesive energy (U₀), as shown in the following equation,

$$δ = \sqrt{{\overline{U}}_{0}} = \sqrt{{U}_{0} / V} \qquad ( 4 )$$

Since long-chain alkanes are nonpolar, and the only intermolecular forces acting on it are dispersion forces, the U₀ of alkanes can be calculated based on the strength of dispersion forces for each CH₂ group.

The exchange parameter values calculated from equations 2, 3 and 4 are plotted for various mixtures at different temperatures in FIG. 7a. For consistency, χ values were taken at room temperature in all of the following calculations. Using room-temperature values for χ, vapor pressure was determined and plotted for different solid components as a function of mole fraction of C₅F₁₂. The vapor pressure elevation/depression for various mixtures calculated from equation 1 are shown in FIG. 6b. The resulting vapor pressure values were used to predict the boiling point (T_{b}) of the solvent, as the boiling point is where vapor pressure equals the ambient pressure (1 atm). Boiling point was thus determined from the Clausius-Clapeyron equation:

$$\frac{1}{{T}_{2}} - \frac{1}{{T}_{1}} = - \frac{R}{Δ {H}_{v}} ln ( \frac{{P}_{2}}{{P}_{1}} ) \qquad ( 5 )$$

where P₁ is the vapor pressure at temperature T₁, P₂ is the vapor pressure at temperature T₂, and ΔHᵥ is the heat of vaporization of the solvent. The boiling point (T_{b}) is thus determined by the following equation,

$${T}_{b} = \frac{Δ {H}_{v} {T}_{r}}{Δ {H}_{v} + R {T}_{r} ln ( {P}_{vap} )} \qquad ( 6 )$$

The resulting values for T_{b} (saturation temperature) are plotted in FIG. 6c. The critical temperature (T_{c}) is the temperature above which a vapor cannot be liquefied at any pressure. Like the boiling point, this temperature is mainly affected by the intermolecular interactions. Hence, an empirical relation between T_{c} and T_{b} was established by using a linear least-squares fit to tabulated literature data for FCs ranging from perfluoromethane (CF₄) to perlfuorodecane (C₁₀F₂₂)². Data with the trendline is shown in FIG. 6d. This relation is given by (R²=0.998):

T_{c}=69.898+1.1443*T_{b} (7)

Combining equations 1, 6 and 7, gives an empirical relation to calculate T_{c} for perfluoropentane and an additional solute:

$${T}_{c} = \frac{1.1443 * Δ {H}_{v} {T}_{r}}{Δ {H}_{v} + R {T}_{r} ln ( {P}_{o} {x}_{F} {e}^{{𝒳 ( 1 - {x}_{F} )}^{2}} )} + 69.898 \qquad ( 8 )$$

Experimentally, the spinodal temperature (Tₛ) is observed to be at 80% to 90% of T_{c}. FIG. 1e and 3a shows the theoretical predictions of the vaporization temperature, critical temperature and spinodal range for a mixture of perfluoropentane with perfluorododecane and octadecane, respectively. Note that the spinodal temperature range does not drop to the experimental temperature range for FC/FC mixtures, whereas it crosses the experimental temperature range for FC/HC mixtures, thereby demonstrating the effects of intermolecular interactions as captured by the exchange parameter (χ). Low-χ mixtures (e.g., FC/FC) lead to enhanced cohesive intermolecular interactions, which in turn lower the vapor pressure and raise the boiling point and spinodal temperature. Conversely, High-χ mixtures (e.g., FC/HC) lead to reduced cohesive intermolecular interactions, which in turn increase the vapor pressure and lower the boiling point and spinodal temperature, effecting vaporization.

Theoretical Phase Diagram for the C₅F₁₂/C₁₈H₃₈ Mixture

The C₅F₁₂/C₁₈H₃₈ binary phase diagram was constructed following Carey. The free energy of mixing was calculated using the equation,

$$\frac{Δ {F}_{m i x}}{N k T} = x ln x + ( 1 - x ) ln ( 1 - x ) + χ x ( 1 - x ) \qquad ( 9 )$$

Here, χ is the exchange parameter for the C₅F₁₂/C₁₈H₃₈ mixture, and x is the mole fraction of C₅F₁₂. The free energy plot was calculated for different temperatures (−25° C. to 750° C. in increments of 7° C.). Each plot has two minima where the system forms separate phases. These plots were then combined to give the phase-transition temperature vs. mole fraction of C₅F₁₂. This plot was inverted to produce the binary phase diagram, as shown in FIG. 7.

The phase diagram for C₅F₁₂/C₁₈H₃₈ system shows that the Upper Critical Solution Temperature (UCST) for this system is above 600° C. At our experimental temperature range, at equilibrium there consist a two-phase region with C₅F₁₂ concentrations of ˜1 and ˜99 mole % in the HC and FC phase respectively. But, these are the concentrations of the bulk at equilibrium. When we look closely at the interface, even with the presence of two-phase region, it was shown from the MD simulations that the HC and FC phase is diffuse, and a range of concentrations exists as shown in FIGS. 3b and 3c.

### Comparison of Vaporization Temperature and o-d Transition Temperatures

From the experiments, it was observed that the endoskeletal droplets with pure HC vaporized at temperatures that are consistently a few degrees below the melting point of the HC used (FIG. 3f). In long-chain HCs, rotator phases (solid order-to-disorder transition) are also seen a few degrees below the melting point. This transition is characterized by the formation of many defects in the long HC chain. Hence, after the o-d transition, there is a sudden increase in entropy, abrupt increase in volume, and more liquid-like behavior in general. This liquid-like behavior of the HC, after transitioning from the ordered solid to the disordered solid state, facilitates mixing between FC and HC molecules and promotes droplet vaporization. FIG. 9a shows the melting point (Tₘ), o-d transition temperature (T_{o-d}) and vaporization temperature (Tᵥₐₚ) for endoskeletal FC/HC droplets comprising different chain-length HCs. It can be observed that Tᵥₐₚ lies below Tₘ, in the rotator phase region. Increasing the temperature increases the extent of superheat for the liquid C₅F₁₂ as well, which may indicate why endoskeletal droplets with longer chain HCs vaporize easily compared to droplets with shorter chain HCs.

Interestingly, alkanes with even or odd numbered carbon lengths show differences in the range of temperatures over which the rotator phase exists. This temperature range was quantified as the difference between the solid-liquid transition temperature (melting point) and the o-d transition temperature. This range is higher for odd alkanes than for even alkanes (FIG. 8c). This temperature range was comparable to the range over which the endoskeletal droplets vaporized. The vaporization temperature range was quantified by using the standard deviation of the temperature spread for vaporization as seen in FIG. 8b. Similar odd/even increasing/decreasing trends in the range of vaporization temperatures can be seen for droplets with pure HC in FIG. 8c. This provides further support that the o-d transition to the rotator phase in the solid HC is responsible for the vaporization of the liquid FC phase.

Furthermore, this o-d transition temperature is lower for mixtures of HC than pure components for C₂₀H₂₄/C₂₂H₅₆ and C₂₂H₄₆/C₂₄H₅₀ mixtures, as seen from their phase diagrams. Interestingly, the vaporization temperatures observed for FC/HC droplets made with these HC mixtures (plotted in FIG. 3g) are also within the rotator phase regions for the phase diagram of the HC only mixtures. Looking at the temperature range, mixtures of HC have a higher range of rotator phase temperatures than the pure components and, similarly, a high range of vaporization temperatures (high standard deviation a values) is also observed for droplets made with mixtures of HC compared to pure HC (FIG. 8d).

### Example 10: Materials and Methods

### Materials

The following chemicals were used as received: perfluoropentane (C₅F₁₂, 98%, Strem Chemicals, Newburyport, MA, USA); perfluorohexane (C₆F₁₄, 99%, Fluoromed, Round Rock, TX, USA); perfluorododecane (>99%, Fluoryx Labs, Carson City, NV, USA), krytox 157 FSH oil (Miller-Stephenson Chemicals, Danbury, CT, USA); 1,2-dibehenoyl-sn-glycero-3-phosphocholine (DBPC) (99%, Avanti Polar Lipids, Alabaster, AL, USA); N-(Methylpolyoxyethylene oxycarbonyl)-1,2-distearoyl-sn-glycero-3-phosphoethanolamine (DSPE-PEG5K) (NOF America, White Plains, NY, USA); Octadecane (99%), Heneicosane (98%), Tricosane (99%), Tetracosane (99%), Chloroform (≥99.9%) (Sigma-Aldrich, St. Louis, MO, USA); Nonadecane (99%, Acros Organics, NJ, USA), Eicosane (99%, Alfa Aesar, Ward Hill, MA, USA), Docosane (98%, TCI, Portland, OR, USA); DiO fluorescent probe (Ex: 484 nm, Em: 501 nm) (Invitrogen, Eugene, OR, USA), ultrapure deionized (DI) water from Millipore Direct-Q (Millipore Sigma, St. Louis, MO, USA).

### Preparation of the Fluorosurfactant (Krytox) Solution

The fluorosurfactant krytox was mixed to a concentration of 0.75% v/v with the FC liquid (C₅F₁₂ or C₆F₁₄, and C₁₂F₂₆) prior to adding in other components, such as water or hydrocarbon.

### Preparation of the Hydrocarbon Surfactant (Lipid) Solution

The lipid solution was formulated by suspending DBPC and DSPE-PEG5K (9:1 molar ratio) at a total lipid concentration of 2 mg/mL in DI water. The lipids were first dissolved and mixed in chloroform in a glass vial, and then the solvent was removed to yield a dry lipid film at 35° C. and under vacuum overnight. The dry lipid film was rehydrated using DI water and then sonicated at 75° C. at low power (3/10) for 10 min to convert the multilamellar vesicles to unilamellar liposomes.

### Synthesis of FC/FC Endoskeletal Droplets

The general reaction scheme for synthesizing the fluorocarbon (FC) liquid and FC solid endoskeletal droplet emulsion is shown in FIG. 1a. The solid (perfluorododecane, C₁₂F₂₆) and liquid (perfluoropentane, C₅F₁₂) FCs were mixed with the fluorosurfactant krytox (0.75% v/v of solution) and DI water, sealed in a glass vial and heated in a water bath to 30-65° C. (depending on solid content) until all the solids melted. This heated mixture was then emulsified using a dental amalgamator (TPC D-650 digital amalgamator, 4400 rpm) for 45 sec. Depending on the content of the solid, the emulsion was either quenched in an ice bath for droplets containing 50% w/w solid content or less, or room temperature water for droplets containing more than 50% w/w content. Perfluorohexane (C₆F₁₄) liquid droplets were prepared in the same way as described above.

### Fluorescent Labeling of FC/FC Endoskeletal Droplets

Fluorescently labelled FC/FC droplets were synthesized (using Krytox as surfactant) as above. 5 μL/mL fluorescent dye (DiO) was added to solid/liquid FC mixture before heating the mixture. DiO was observed to dissolve into the FC liquid phase, but it was excluded from the FC solid phase.

### Synthesis of FC/HC Endoskeletal Droplets

Endoskeleton made from Pure HC. The general reaction scheme for synthesizing FC/HC endoskeletal droplets is shown in FIG. 2a. The solid HC was weighed (60 mg) in a glass vial and then heated in a water bath to a temperature that was 3° C. above the melting point of the HC used (Table 1). This was done to prevent HC crystals from dispersing into the aqueous liquid prior to emulsification. Then the HC phase was quenched in an ice water bath to form a solid film. For emulsion stabilized by the fluorosurfactant, 0.75% v/v krytox (30 μL) was added and then the aqueous phase (4 mL) was chilled in ice water bath. For emulsion stabilized by the hydrocarbon surfactant lipid, chilled lipid solution (4 mL) was added to the quenched HC film. Then, 200 μL of C₅F₁₂ was pipetted into the HC/aqueous mixture in the glass vial. The vial was then sealed with a crimper (Wheaton, Millville, NJ, USA), heated to 3° C. above the melting point of the HC used, and bath sonicated for 1 min at 240 W to pre-suspend the liquid FC and HC phases. This mixture was then emulsified using the amalgamator. The resulting emulsion was quenched in ice water to form the final FC/HC endoskeletal droplets.

Endoskeleton Made from a Mixture of HCs. The required ratio of different HC (20, 40, 60 and 80 mole % of C₂₂H₄₆ in C₂₄ or C₂₄H₅₀ in C₂₂H₄₆) were weighed (to make a total of 60 mg) in a glass vial and then heated in a water bath at a temperature that was 10° C. higher than the melting point of the higher chain length HC (55° C. for C₂₀H₄₂/C₂₂H₄₆ mixture and 60° C. for C₂₂H₄₆/C₂₄H₅₀ mixture). This was then quenched in an ice water bath to form a solid film at the bottom of the vial. The procedure for synthesizing FC/HC endoskeletal droplets was then used as described above. Only the hydrocarbon surfactant lipids were used for these endoskeletal droplets.

### Sizing and Counting the Droplets

Droplet size and concentration were measured using an Accusizer 780A (PSS Nicomp, Port Richey, FL, USA), which sizes individual particles as they pass by a laser using forward and side scattering.

### Optical Heating Experiments

The optical heating experimental setup consisted of a glass slide (25.4×76 mm, Fisher Scientific) heated by two flexible heaters (Kapton KHLV-102/10-P, Omega Engineering, Norwalk, CT, USA). The heaters were attached to a power supply (Agilent E3640A, Agilent Technologies, Santa Clara, CA, USA). The sample was diluted by 3:7 with DI water and pipetted (100 μl) into the well of a custom microscope chamber. A spacer with a well was made by 3D printing (Stratasis Objet30, Eden Prairie, MN, USA) with two holes for K-type thermocouples (Omega Engineering 5TC-TT-K-36-36, Norwalk, CT, USA). The 3D printed spacer was sandwiched between a glass slide and cover slip (24×50 mm, Fisher Scientific) using a thin film of vacuum grease (Dow Corning, Houston, TX, USA). A proportional-integral-differential (PID) controller was built and implemented to control the temperature and temperature rise rate of the chamber. The chamber was attached to an inverted microscope (Nikon Eclipse Ti2 Inverted Microscope, Melville, NY, USA) fitted with Nikon Plan Fluor 4× and 10× objectives. The microscope was attached to a digital CMOS camera (Hamamatsu C11450 ORCA Flash-4.0LT, Bridgewater, NJ, USA). Temperature points were collected using a NI-9212 data acquisition system attached to an NI-TB-9212 isothermal terminal block and run with a custom-built LabVIEW program (National Instruments, Austin, TX, USA) to acquire and store data on the computer (microscope images with a time and temperature stamp) and to control the heater. One thermocouple was used to record the temperature of the sample near the heater, and the other was used to record the temperature of the sample at the center between the two heaters. The thermocouple measuring the temperature of the sample close to the heater was set as the controlled variable owing to the faster time constant and hence greater controller stability. The thermocouple used to measure the temperature at the center between the heaters was considered to be the true sample temperature. The typical difference was about 2-3° C. between the center and edge of the sample holder. The microscope stage was translated to find a field of view with 2 to 15 droplets close to the center thermocouple. Image acquisition and data collection started when the PID controller was turned on.

FC/FC Endoskeletal Droplets. For FC/FC droplets, the sample was slowly heated from room temperature until all the solid disk structures inside the droplets melted. Then the heater was turned off as the sample was allowed to cool slowly under ambient conditions back to room temperature. For each composition, 3-4 samples were synthesized, and 3-4 separate heating runs were performed per sample (n>20 droplets per composition).

FC/HC Endoskeletal Droplets. For FC/HC droplets, the sample was slowly heated from room temperature to 50° C. Images were captured at a rate of 5 frames/sec. Vaporization was observed by conversion of the semi-transparent drop to a larger, high-contrast bubble. The number of bubbles was counted in each frame and coded to the corresponding time and temperature. The normalized number of bubbles (normalized to 1 by dividing by total maximum number of bubbles formed at the end of the run) was plotted against the sample temperature (FIG. 3d). A normal cumulative distribution function was fit to the data using OriginPro (OriginLab, Northampton, MA, USA). The temperature corresponding to 50% vaporization from the fit was selected as the Tᵥₐₚ (vaporization temperature) for the droplet sample. This process was repeated at least 3 times per sample, for at least 3 separately prepared samples per composition. Hence, at least 9 plots were formed for each FC/HC mixture. The mean and standard deviation for Tᵥₐₚ is plotted in FIG. 3e for each composition. The same process was repeated for all the compositions and for the different surfactant coatings. This procedure was done for both pure HC and mixed HC droplets.

### Molecular Dynamics Simulations of FC/HC Interface

Models of perfluoropentane (C₅F₁₂) molecules and octadecane (C₁₈H₃₈) molecules were prepared in all-atom resolution using the Materials Studio program. Two simulation boxes containing 1890 C₅F₁₂ molecules and 1062 C₈H₃₈ molecules, respectively, were pre-equilibrated for 20 and 10 ns respectively until they reached bulk density and equilibrium. To explore the interfacial properties, the two bulk components were then combined with a 15.7 Å thick platinum slab added to the bottom of the simulation box to avoid periodic interactions between the two components. The final simulation box was at a size of 43.2×43.2×666.6 Å3, which was large enough to represent bulk properties and observe interfacial behavior. Simulations of the final simulation box were run for 18 ns when the system reached equilibrium (FIG. 3b). Density profiles of the C₅F₁₂ and C₁₈H₃₈ molecules were calculated from the last 3 ns of the simulation, and the first 1 ns, and used to create a plot of mole fraction of each component against distance at the material interface. The raw mole fraction data was smoothed with a 3rd order polynomial using the Savitzky-Golay method (FIG. 3c).

A smaller simulation was run to obtain energy values of a system of HC and FC as it mixes. The system contained 630 C₅F₁₂ and 354 C₁₈H₃₈ molecules in order to keep the same ratio as the previous simulation. FC and HC were fully separated initially. Systems were run for over 50 ns to equilibrium and energies were calculated using 0.5 ns block averages for the next 45 ns with the equilibrium energy of the pre-mixed system set as the 0 energy reference point. A smoothing function was applied to both curves, and energy values were converted from kcal/mol to mJ/m2 based off the cross-sectional area of the initially separated FC/HC simulation cell (42.36×42.36 Å).

Molecular dynamics simulations were carried out in the NPT ensemble using the LAMMPS program and the PCFF force field^{1,2}. The time step was 1 fs, the summation of Lennard-Jones interactions included at cutoff at 1.2 nm, and the summation of electrostatic interactions was carried out in high accuracy (10⁻⁵) using the PPPM method. Temperature and pressure were maintained at 308.15 K and 1 atm to match experimental conditions.

### Ultrasound Heating Experiment Setup

The ultrasound experimental setup (FIG. 4a) consisted of a custom-built acrylic chamber. The temperature of the water bath was controlled by an immersion heater (Heat-O-Matic 335, 115 V, 500W, Cole-Palmer, Vernon Hills, IL, USA). The sample was pumped through dialysis tubing (6.37 mm dry diameter, Fisher Scientific), which was fully submerged in the water bath. The chamber consisted of two magnetic stirrers and sat atop two magnetic stir plates continuously stirring the water bath for uniform heating. A magnetic stirrer was placed inside the dialysis tubing as well to ensure that the sample was continuously mixed. A k-type thermocouple (Omega Engineering 5TC-TT-K-36-36, Norwalk, CT, USA) was used to measure the temperature of the water bath with the tip placed close to the sample tubing. A rubber layer was attached to the wall of the chamber to prevent acoustic reflection from the acrylic. Temperature was acquired using a NI-9212 DAQ (National Instruments, Austin, TX, USA). Ultrasound images were collected using an ultrasound transducer (Acuson 15L8, Siemens, Tarrytown, NY, USA) attached to a clinical ultrasound system (Acuson Sequoia C512, Siemens). B-mode images were taken at a frequency of 8 MHz and tissue attenuation-derated mechanical index of 0.29 for all the experiments. The 2D gain was set to 0 dB and dynamic range was set to 50 dB for all the images taken. Images were acquired using LabVIEW. The droplets were diluted to 10⁸ droplets/mL and injected by syringe into the dialysis tubing. The tubing was clamped on both ends as to prevent leakage. An image was acquired every second throughout the heating process. Image analysis was done using ImageJ (NIH, USA). A region of interest (ROI) was created inside the tube (FIGS. 4b-c), such that the walls of the tubing do not affect the total video intensity. The total (summed) video intensity inside the ROI was calculated for each frame, normalized to the maximum video intensity achieved in that acquisition, and plotted against time (and hence temperature) for each run. A representative plot is shown in FIG. 4d. The plot obtained was a bell shaped curve owing to droplet vaporization and subsequent bubble destruction; hence, a Gaussian function was fit to the normalized curve (normalized to unity) as seen in the figure. The temperature at 50% video intensity was chosen to be the vaporization temperature (Tᵥₐₚ). At least 3 runs were done for each sample and at least 3 different samples were prepared for each FC/HC mixture. The mean and standard deviation of all the runs is plotted in FIG. 4e for each composition. The process was repeated for each surfactant (fluorocarbon and hydrocarbon).

### TABLES

TABLE 1
List of Materials and Properties

| | | | Molecular | | Melting | Boiling | Critical |
|---|---|---|---|---|---|---|---|
| | Molecular | | Weight | Density | Point | point | Temperature |
| Chemical Name | Formula | CAS # | (g/mol) | (g/cc) ¹ | (° C.) | (° C.) | (° C.) |
| Perfluoropentane | C₅F₁₂ | 678-26-2 | 288.04 | 1.63 | −125 | 29.2 | 147.4 |
| Perfluorohexane | C₆F₁₄ | 355-42-0 | 338.042 | 1.6910 | −86.1 | 57.2 | — |
| Perfluorododecane | C₁₂F₂₆ | 307-59-5 | 638.0869 | 1.73 | 75 | — | — |
| Octadecane | C₁₈H₃₈ | 593-45-3 | 254.495 | 0.7768 | 28.17 | — | — |
| Nonadecane | C₁₉H₄₀ | 629-92-5 | 268.521 | 0.7855 | 31.5 | — | — |
| Eicosane | C₂₀H₄₂ | 112-95-8 | 282.547 | 0.7886 | 36.48 | — | — |
| Heneicosane | C₂₁H₄₄ | 629-94-7 | 296.574 | 0.7919 | 40.4 | — | — |
| Docosane | C₂₂H₄₆ | 629-97-0 | 310.600 | 0.7944 | 43.8 | — | — |
| Tricosane | C₂₃H₄₈ | 638-67-5 | 324.627 | 0.7785 | 47.4 | — | — |
| Tetracosane | C₂₄H₅₀ | 646-31-1 | 338.65 | 0.7991 | 50.3 | — | — |

### REFERENCES

The following references are hereby incorporated by reference into the specification:
1. Zarzar, L. D. et al. Dynamically reconfigurable complex emulsions via tunable interfacial tensions. Nature 518, 520-524 (2015).
2. Sheeran, P. S. & Dayton, P. A. Phase-change contrast agents for imaging and therapy. Curr. Pharm. Des. 18, 2152-2165 (2012).
3. Shang, L., Cheng, Y. & Zhao, Y. Emerging Droplet Microfluidics. Chem. Rev. 117, 7964-8040 (2017).
4. Peng, H. et al. n-Alkanes Phase Change Materials and Their Microencapsulation for Thermal Energy Storage: A Critical Review. Energy Fuels 32, 7262-7293 (2018).
5. Kim, J. Spray cooling heat transfer: The state of the art. Int. J. Heat Fluid Flow 28, 753-767 (2007).
6. Theberge, A. B. et al. Microdroplets in Microfluidics: An Evolving Platform for Discoveries in Chemistry and Biology. Angew. Chem. Int. Ed. 49, 5846-5868 (2010).
7. Amole, C. et al. Dark Matter Search Results from the PICO-60 C 3 F 8 Bubble Chamber. Phys. Rev. Lett. 118, (2017).
8. Lea-Banks, H., O'Reilly, M. A. & Hynynen, K. Ultrasound-responsive droplets for therapy: A review. J. Control. Release Off. J. Control. Release Soc. 293, 144-154 (2019).
9. Mountford, P. A. & Borden, M. A. On the thermodynamics and kinetics of superheated fluorocarbon phase-change agents. Adv. Colloid Interface Sci. 237, 15-27 (2016).
10. Krafft, M. P. Fluorocarbons and fluorinated amphiphiles in drug delivery and biomedical research. Adv. Drug Deliv. Rev. 47, 209-228 (2001).
11. Kripfgans, O. D., Fowlkes, J. B., Miller, D. L., Eldevik, O. P. & Carson, P. L. Acoustic droplet vaporization for therapeutic and diagnostic applications. Ultrasound Med. Biol. 26, 1177-1189 (2000).
12. Sheeran, P. S., Luois, S. H., Mullin, L. B., Matsunaga, T. O. & Dayton, P. A. Design of ultrasonically-activatable nanoparticles using low boiling point perfluorocarbons. Biomaterials 33, 3262-3269 (2012).
13. Kabalnov, A., Klein, D., Pelura, T., Schutt, E. & Weers, J. Dissolution of multicomponent microbubbles in the bloodstream: 1. theory. Ultrasound Med. Biol. 24, 739-749 (1998).
14. Vezeridis, A. M. et al. Fluorous-phase iron oxide nanoparticles as enhancers of acoustic droplet vaporization of perfluorocarbons with supra-physiologic boiling point. J. Controlled Release 302, 54-62 (2019).
15. Caggioni, M., Bayles, A. V., Lenis, J., Furst, E. M. & Spicer, P. T. Interfacial stability and shape change of anisotropic endoskeleton droplets. Soft Matter 10, 7647-7652 (2014).
16. Dill, K. A. & Bromberg, S. Molecular Driving Forces: Statistical Thermodynamics in Biology, Chemistry, Physics, and Nanoscience. (Garland Science, 2011).
17. Heinz, H., Lin, T.-J., Kishore Mishra, R. & Emami, F. S. Thermodynamically Consistent Force Fields for the Assembly of Inorganic, Organic, and Biological Nanostructures: The INTERFACE Force Field. Langmuir 29, 1754-1765 (2013).
18. Zhou, J. et al. Observing crystal nucleation in four dimensions using atomic electron tomography. Nature 570, 500 (2019).
19. Muller, M., MacDowell, L. G., Virnau, P. & Binder, K. Interface properties and bubble nucleation in compressible mixtures containing polymers. J. Chem. Phys. 117, 5480-5496 (2002).
20. Chen, J. et al. Building two-dimensional materials one row at a time: Avoiding the nucleation barrier. Science 362, 1135-1139 (2018).
21. Mondieig, D., Rajabalee, F., Metivaud, V., Oonk, H. A. J. & Cuevas-Diarte, M. A. n-Alkane Binary Molecular Alloys. Chem. Mater. 16, 786-798 (2004).
22. Briard, A.-J., Bouroukba, M., Petitjean, D., Hubert, N. & Dirand, M. Experimental Enthalpy Increments from the Solid Phases to the Liquid Phase of Homologous n-Alkane Series (C₁₈ to C₃₈ and C₄₁, C₄₄, C₄₆, C₅₀, C₅₄, and C₆₀). J. Chem. Eng. Data 48, 497-513 (2003).
23. Dirand, M. et al. Normal Alkanes, Multialkane Synthetic Model Mixtures, and Real Petroleum Waxes: Crystallographic Structures, Thermodynamic Properties, and Crystallization. J. Chem. Eng. Data 47, 115-143 (2002).
24. CRC Handbook of chemistry and Physics. (CRC Press, 2019).
25. Stephenson, R. M. & Malanowski, S. Vapor-Liquid Critical Constants of fluids. in Handbook of the Thermodynamics of Organic Compounds 527 (Elsevier, 1987).
26. NIST Chemistry WebBook, NIST Standard Reference Database Number 69. (National Institute of Standards and Technology).
27. Carey, V., P. Liquid-Vapor Phase-Change Phenomena. (Taylor & Francis, 2008).
28. Dill, K. A. & Bromberg, S. Molecular Driving Forces: Statistical Thermodynamics in Biology, Chemistry, Physics, and Nanoscience. (Garland Science, 2011).
29. Brandrup, J., Immergut, E. H. & Grulke, E. A. Polymer Handbook. (Wiley, 1999).
30. Young, R. J. & Lovell, P. A. Introduction to Polymers. (CRC Press, 2011).
31. Barton, A. F. M. CRC Handbook of Solubility Parameters and Other Cohesion Parameters. (CRC Press, 1983).
32. Israelachvili, J. N. Van der Waals Forces. in Intermolecular and Surface Forces 107-130 (Academic Press, 2011).
33. Debenedetti, P. G. Metastable Liquids: Concepts and Principles. (Princeton University Press, 1996).
34. Fisher, C. H. Boiling Point Gives Critical Temperature. Chemical Engineering 96, 157-158 (1989).
35. Mountford, P. A., Thomas, A. N. & Borden, M. A. Thermal Activation of Superheated Lipid-Coated Perfluorocarbon Drops. Langmuir 31, 4627-4634 (2015).
36. Dirand, M. et al. Normal Alkanes, Multialkane Synthetic Model Mixtures, and Real Petroleum Waxes: Crystallographic Structures, Thermodynamic Properties, and Crystallization. Journal of Chemical & Engineering Data 47, 115-143 (2002).
37. Dirand, M., Achour, Z., Jouti, B., Sabour, A. & Gachon, J. C. Binary Mixtures of n-Alkanes. Phase Diagram Generalization: Intermediate Solid Solutions, Rotator Phases. Molecular Crystal and Liquid Crystals Science and Technology. Section A. Molecular Crystals and Liquid Crystals 275, 293-304 (1996).
38. Sabour, A., Dirani, M. & Hoch, M. THERMODYNAMIC PROPERTIES OF THE n-ALKANES C₁₉H₄₀ TO C₂₆H₅₄ AND THEIR BINARY PHASE DIAGRAMS. Journal of Thermal Analysis 51, 477-488 (1988).
39. Mondieig, D., Rajabalee, F., Metivaud, V., Oonk, H. A. J. & Cuevas-Diarte, M. A. n-Alkane Binary Molecular Alloys. Chemistry of Materials 16, 786-798 (2004).
40. Luth, H. & Nyburg, S. C. Crystallographic and calorimetric Phase Studies of the n-Eicosane, C₂₀H₄₂:n-docosane, C₂₂H₄₆ System. Molecular crystals and liquid crystals 27, 337-357 (1974).
41. Sun, H. Ab initio calculations and force field development for computer simulation of polysilanes. Macromolecules 28, 701-712 (1995).
42. Plimpton, S. Fast Parallel Algorithms for Short-Range Molecular Dynamics. Journal of Computational Physics 117, 1-19 (1995).

1-15. (canceled)

16. A method of tuning the vaporization temperature of a droplet comprising:
generating liquid phase fluorocarbon vaporizable droplet; and
introducing one or more solid phase compounds to said liquid phase fluorocarbon vaporizable droplet, wherein said one or more solid phase compounds forms a solid state exoskeleton or endoskeleton shell that tunes the vaporization temperature of said fluorocarbon vaporizable droplet.

17. The method of claim 16 wherein said liquid phase fluorocarbon vaporizable droplet comprises a liquid phase perfluoropentane vaporizable droplet, or a liquid phase perfluorohexane vaporizable droplet.

18. The method of claim 16 wherein said solid phase compounds comprise a compound selected from the group consisting of:
at least one solid phase fluorocarbon (FC);
at least one solid phase hydrocarbon (HC);
a mixture of at least one solid phase FC and at least one solid phase HC; and
a mixture of two or more solid phase HCs.

19. The method of claim 18 wherein said solid phase FC comprises a solid phase perfluorododecane.

20. The method of claim 19 wherein said solid phase perfluorododecane forms a solid endoskeleton shell that is encapsulated by said liquid phase perfluorohexane vaporizable droplet.

21. The method of claim 20 wherein said endoskeleton shell comprises a disk-shaped solid structure encapsulated by said liquid phase fluorocarbon vaporizable droplet.

22. The method of claim 19 wherein the liquid phase perfluoropentane vaporizable droplet encapsulating the perfluorododecane solid endoskeleton shell stabilizes said perfluoropentane vaporizable droplet increasing the temperature of vaporization of the droplet.

23. The method of claim 20 wherein the liquid phase perfluorohexane vaporizable droplet encapsulating the perfluorododecane solid endoskeleton shell stabilizes said perfluorohexane vaporizable droplet increasing the vaporization temperature of the droplet.

24. The method of claim 18 wherein said at least one solid phase HC comprises a solid phase HC selected from the group consisting of: a straight chain alkane having a chain length between 18-24 carbons, octadecane, eicosane, docosane, tetracosane, or a mixture of the same.

25. (canceled)

26. The method of claim 16 wherein said liquid phase fluorocarbon droplet comprises:
a liquid phase perfluoropentane vaporizable droplet or a liquid phase perfluorohexane vaporizable droplet incorporating a solid phase compound comprising both:
at least one solid phase HC;
at least one solid phase FC; and
wherein said solid phase HC and said solid phase FC form a solid state endoskeleton shell that decreases the vaporization temperature of the droplet.

27. The method of claim 26 wherein said solid phase HC comprises a straight chain alkane having a chain length between 18-24 carbons.

28. The method of claim 26 wherein said solid phase FC comprises solid phase perfluorododecane.

29. The method of claim 16 wherein said liquid phase fluorocarbon comprises a liquid phase perfluoropentane vaporizable droplet incorporating a solid phase compound comprising two or more solid phase HCs wherein said two or more solid phase HCs form a solid state endoskeleton shell and/or exoskeleton shell that decreases the vaporization temperature of the droplet.

30. The method of claim 29 wherein said two or more solid phase HCs comprise two or more straight chain alkanes having a chain length between 18-24 carbons selected from the group consisting of: octadecane, eicosane, docosane, tetracosane, or a mixture of the same.

31-32. (canceled)

33. A method of fabricating a tunable fluorocarbon vaporizable droplet having a solid state architecture comprising:
heating a quantity of at least one fluorocarbon to form a liquefied fluorocarbon;
introducing at least one fluorosurfactant to said liquefied fluorocarbon;
introducing a quantity of at least one solid state fluorocarbon to said liquefied fluorocarbon forming a liquid and solid state fluorocarbon solution;
heating said liquid and solid state fluorocarbon solution;
extruding or emulsifying said liquid and solid state fluorocarbon solution forming a plurality of fluorocarbon vaporizable droplet; and
cooling said plurality of fluorocarbon vaporizable droplets wherein said solid state fluorocarbon forms a solid state endoskeleton shell configured to tune the vaporization temperature of said fluorocarbon vaporizable droplet.

34-35. (canceled)

36. The method of claim 33 wherein said step of heating comprises heating a quantity of at least one perfluoropentane to form a liquefied perfluoropentane.

37-38. (canceled)

39. The method of claim 33 wherein said step of introducing a quantity of at least one solid state fluorocarbon to said liquefied fluorocarbon comprises the step of introducing a quantity of perfluorododecane to said liquefied fluorocarbon.

40. The method of claim 39 wherein the perfluorododecane solid endoskeleton shell stabilizes said perfluoropentane vaporizable droplet increasing the temperature of vaporization of the droplet

41. A method of fabricating a tunable fluorocarbon vaporizable droplet having a solid state architecture comprising:
liquefying a quantity of at least one solid state hydrocarbon to form a liquefied hydrocarbon;
introducing at least one surfactant or lipid solution to said liquefied hydrocarbon;
introducing a quantity of deionized water to said liquefied hydrocarbon;
introducing a quantity of at least one liquid state fluorocarbon to said liquefied hydrocarbon forming a liquid and solid state solution;
heating said liquid and solid state solution;
extruding or emulsifying said liquid and solid state solution forming a plurality of fluorocarbon vaporizable droplets; and
quenching said plurality of fluorocarbon vaporizable droplets wherein said solid state hydrocarbon forms a solid state exoskeleton or endoskeleton shell configured to tune the vaporization temperature of said fluorocarbon vaporizable droplet.

42-45. (canceled)

46. The method of claim 41 wherein said liquid state fluorocarbon comprises liquid state perfluoropentane.

47. (canceled)

48. The method of claim 41 wherein said introducing a quantity of at least one liquid state fluorocarbon to said liquefied hydrocarbon forming a liquid and solid state solution comprises the step of introducing a quantity of liquid state perfluorododecane to said liquefied hydrocarbon forming a liquid and solid state solution.

49-50. (canceled)
